(19) United States
(12) Patent Application Publication
(10) Pub. No.: US 2026/0042338 A1
(43) Pub. Date: Feb. 12, 2026

(54) VEHICLE AIR VENT

(71) Applicant: HYUNDAI MOBIS CO., LTD., Seoul (KR)

(72) Inventor: Seung Cheol KIM, Yongin-si (KR)

(73) Assignee: HYUNDAI MOBIS CO., LTD., Seoul (KR)

(21) Appl. No.: 18/918,368

(22) Filed: Oct. 17, 2024

(30) Foreign Application Priority Data
Aug. 7, 2024 (KR) 10-2024-0105070

(51) Int. Cl. B60H 1/34

(52) U.S. Cl. CPC B60H 1/3421; B60H 2001/3478

(57) ABSTRACT

A vehicle air vent for being installed in a vehicle to guide air in a passenger compartment of the vehicle is provided. The vehicle air vent includes: a first wing assembly including a first wing for guiding air toward at least one of a ceiling surface of the passenger compartment, a floor surface of the passenger compartment, or a combination thereof; a second wing assembly including a plurality of second wings for guiding air toward a side of the passenger compartment; and a single actuator disposed between the first wing assembly and the second wing assembly. The single actuator generates a mechanical force to rotate the first wing and the second wing.

### CROSS-REFERENCE TO RELATED APPLICATION(S)

The present application claims priority to and the benefit under 35 USC § 119 of Korean Patent Application No. KR 10-2024-0105070 filed Aug. 7, 2024, in the Korean Intellectual Property Office, the entire disclosure of which is incorporated by reference for all purposes.

### BACKGROUND OF THE INVENTION

### 1. Field

The present invention relates to a vehicle air vent, and more particularly, a vehicle air vent in which a single actuator is capable of controlling multiple wings.

### 2. Description of the Related Art

An air vent is a device connected to an air conditioning system to guide the air discharged from the air conditioning system into the interior of a vehicle The air vent may include a housing for the air to flow through, a front wing disposed inside the housing to control the airflow direction right or left, a rear wing disposed inside the housing to control the airflow direction up or down, and a knob coupled to the rear wing and manipulated by a user.

The conventional air vent is coupled to the cockpit of the vehicle to be exposed to the passenger compartment, where the user manipulates the front wing or the rear wing through the knob. However, the front wing and the knob are exposed to the passengers to compromise the vehicle's aesthetics. As a result, there is a growing demand for air vent designs that eliminate the knob from the air vent's configuration and hide the front wing from the passengers.

To this end, a plurality of actuators are employed, each coupled to the front wing and the rear wing, to rotate the front wing and the rear wing independently to the extent that the front wing remains unexposed to the passengers.

However, employing a plurality of actuators leads to the problem of increased manufacturing costs, thereby deteriorating productivity. Therefore, there is a growing need for a configuration that allows control of both the front wing and the rear wing through a single actuator.

### SUMMARY OF THE INVENTION

The present invention is proposed to address the issues described above. An object of the present invention is to provide an improved vehicle air vent configured to control both the front wing and the rear wing through a single actuator.

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In a general aspect of the disclosure, a vehicle air vent for being installed in a vehicle to guide air in a passenger compartment of the vehicle, includes: a first wing assembly including a first wing for guiding air toward at least one of a ceiling surface of the passenger compartment, a floor surface of the passenger compartment, or a combination thereof; a second wing assembly including a plurality of second wings for guiding air toward a side of the passenger compartment; and a single actuator disposed between the first wing assembly and the second wing assembly, wherein the single actuator is configured to generate a mechanical force to rotate the first wing and the plurality of second wings.

The vehicle air vent may further include: a housing for accommodating the first wing and the plurality of second wings therein, the housing including a path for air to flow therethrough; and a rotating member connected to the actuator, wherein the rotating member is rotated by the mechanical force generated by the actuator to operate the first wing and the plurality of second wings.

The actuator and the rotating member may be disposed outside of the housing.

The vehicle air vent may further include: a first control unit rotatably coupled to the housing and configured to control the rotation direction and rotation angle of the first wing while rotating in conjunction with the rotation of the rotating member, wherein the first control unit may include: a first gear unit for rotating the first wing upward while rotating in selective contact with the rotating member reciprocating along a predetermined section; and a second gear unit for rotating the first wing downward while rotating in selective contact with the rotating member reciprocating along a predetermined section.

The first gear unit may include: a gear (1-1) for rotating in contact with the rotating member rotating in a first rotation direction; and a gear (1-2) for rotating in contact with the rotating member rotating in a second rotation direction, wherein the second gear unit may include: a gear (2-1) for rotating in contact with the rotating member rotating in the second rotation direction; and a gear (2-2) for rotating in contact with the rotating member rotating in the first rotation direction.

The first wing assembly may include a first connecting block coupled to the first wing and serving as a rotation center of the first wing, wherein the first control unit may include a shaft connecting the first gear unit and the second gear unit and a second connecting block coupled to the shaft and engaging the first connecting block in a state of being disposed inside the housing, and wherein the first wing and the first connecting block may rotate in a direction opposite the rotation direction of the second connecting block while rotating in conjunction with the rotation of the second connecting block.

The vehicle air vent may further include: a second control unit disposed outside the housing and configured to control the rotation direction and the rotation angle of the plurality of second wings while rotating in conjunction with the rotation of the rotating member, wherein the second control unit may include: a third gear unit for rotating the plurality of second wings in a first rotation direction while rotating in selective contact with the rotating member reciprocating along a predetermined section; and a fourth gear unit for rotating the plurality of second wings in a second rotation direction opposite the first rotation direction while rotating in selective contact with the rotating member reciprocating along a predetermined section.

The third gear unit may include: a gear unit (3a) including a gear (3-1) for rotating in contact with the rotating member rotating in the second rotation direction, and a gear (3-2) coupled to the gear (3-1) and coupled to any one of the plurality of second wings; and a gear unit (3b) including a gear (3-3) for rotating in contact with the rotating member rotating in the first rotation direction, and a gear (3-4) coupled to the gear (3-3) and rotatably coupled to the housing.

The fourth gear unit may include: a gear unit (4a) including a gear (4-1) for rotating in contact with the rotating member rotating in the first rotation direction, and a gear (4-2) coupled to the gear (4-1) and coupled to any one of the plurality of second wings; and a gear unit (4b) including a gear (4-3) for rotating in contact with the rotating member rotating in the second rotation direction, and a gear (4-4) coupled to the gear (4-3) and rotatably coupled to the housing.

The first control unit and the second control unit may be disposed on a rotation path of the rotating member.

In another general aspect of the disclosure, an air vent to guide air in a passenger compartment of a vehicle, includes: a first wing assembly including a first wing; a second wing assembly including a second wing; a single actuator disposed between the first wing assembly and the second wing assembly; and a processor configured to control the single actuator to provide a mechanical force, wherein the processor is further configured to control the actuator to at least one of: actuate the first wing assembly to rotate the first wing to guide air toward at least one of a ceiling surface of the passenger compartment, a floor surface of the passenger compartment, or a combination thereof; actuate the second wing assembly to rotate the second wing to guide air toward a left side or a right side of the passenger compartment; or a combination thereof.

The air vent may further include: a housing for accommodating the first wing and the second wing therein, the housing including a path for air to flow therethrough; and a rotating member connected to the actuator, wherein the rotating member may be rotated by the mechanical force generated by the actuator to operate the first wing and the second wing.

The air vent may further include: a first control unit rotatably coupled to the housing, the first control unit including a first gear set and a second gear set, wherein the processor may be further configured to: control the first control unit to control the rotation direction and rotation angle of the first wing while rotating in conjunction with the rotation of the rotating member, control the first gear set to rotate the first wing upward while rotating in selective contact with the rotating member reciprocating along a predetermined section; and control the second gear set to rotate the first wing downward while rotating in selective contact with the rotating member reciprocating along a predetermined section.

### BRIEF DESCRIPTION OF THE DRAWINGS

FIG. 1 is a perspective view of a vehicle air vent according to an embodiment of the present invention.

FIG. 2 is an exploded view of a vehicle air vent.

FIG. 3 is a view illustrating a housing and a garnish.

FIG. 4 is a cross-sectional view illustrating the inside of a housing and a garnish in a state where the garnish is coupled to the housing.

FIG. 5 is a perspective view of a first wing assembly.

FIG. 6 is a cross-sectional view illustrating a first wing assembly coupled to the inside of a housing.

FIG. 7 is a perspective view of a second wing assembly.

FIG. 8 is a cross-sectional view illustrating a second wing assembly coupled to the inside of a housing.

FIG. 9 is a front view of a first control unit.

FIG. 10 is a perspective view illustrating a first gear unit.

FIG. 11 is a perspective view illustrating a second gear unit.

FIG. 12 is a view illustrating a state in which a first connecting block of a first wing assembly and a second connecting block of a first control unit are in contact with each other inside a housing.

FIG. 13 is a view illustrating a second control unit.

FIG. 14 is a view illustrating a second control unit coupled to a second wing assembly.

FIG. 15 is a view illustrating a second control unit disposed outside a housing.

FIG. 16 is a view illustrating an actuator and a rotating member disposed outside a housing.

FIG. 17 is a view illustrating a disposition relationship between a first control unit, a second control unit, an actuator, and a rotating member.

FIG. 18a is a view illustrating a process of a rotating member coming into contact with a 1-1 gear of a first control unit.

FIG. 18b is a view illustrating a process of a rotating member coming into contact with a 1-2 gear of a first control unit.

FIG. 19 is a view illustrating a moving path of air toward a second guide portion of a housing by the rotation of a first wing.

FIG. 20a is a view illustrating a process of a rotating member coming into contact with a 2-1 gear of a first control unit.

FIG. 20b is a view illustrating a process of a rotating member coming into contact with a 2-2 gear of a first control unit.

FIG. 21 is a view illustrating a moving path of air toward a first guide portion of a housing by the rotation of a first wing.

FIG. 22a is a view illustrating a process of a rotating member coming into contact with a 3-1 gear of a second control unit.

FIG. 22b is a view illustrating a process of a rotating member coming into contact with a 3-3 gear of a second control unit.

FIG. 23 is a view illustrating a second wing rotated leftward.

FIG. 24a is a view illustrating a process of a rotating member coming into contact with a 4-1 gear of a second control unit.

FIG. 24b is a view illustrating a process of a rotating member coming into contact with a 4-2 gear of a second control unit.

FIG. 25 is a view illustrating a second wing rotated rightward.

FIG. 26 is a view illustrating an air volume control gear and a damper disposed near an inlet portion of a housing.

### DETAILED DESCRIPTION

While the present invention may be subject to various modifications and may have several embodiments, specific embodiments will be illustrated and described. However, it is to be understood that this is not intended to limit the present invention to a particular embodiment and that all modifications, equivalents, or substitutes that fall within the scope of the spirit and technology of the present invention are included.

The terms including ordinal numbers such as first, second, and the like may be used to describe various components, but the components are not to be limited by the terms. The terms may only be used to distinguish one component from another. For example, a second component may be named a first component and a first component may similarly be named a second component without deviating from the scope of the rights of the present invention. The term and/or includes a combination of a plurality of related listed items or any item among a plurality of related listed items.

It is to be understood that when a component is referred to as being “connected” or “coupled” to another component, the component may be directly connected or coupled to the another component, but other components may be interposed therebetween. In contrast, it is to be understood that when a component is referred to as being “directly connected” or “directly coupled” to another component, no other component is interposed.

In the description of embodiments, when one component is described as being formed “on or under” the other components, the two components may be in direct contact with each other or one or more components may be disposed between the two components to form indirect contact. Further, the expression “on or under” may refer to both the upward and downward directions with respect to a given component.

The terms used in the present application are used to describe specific embodiments only and are not intended to limit the present invention thereto. Singular expressions include plural expressions unless the context explicitly indicates otherwise. In the present application, terms such as “comprise” or “have” are intended to indicate the presence of implemented features, numbers, steps, manipulations, components, parts, or combinations thereof described in the specification and are not to be understood to preclude the presence or additional possibilities of one or more of other features, numbers, steps, manipulations, components, parts or combinations thereof.

Unless otherwise defined, all terms used herein, including technical or scientific terms, are intended to have the same meaning as commonly understood by those skilled in the art to which the present invention pertains. Such terms as those defined in commonly used dictionaries are to be construed to have meaning consistent with their meanings in the context of the relevant art and are not to be construed in an idealized or unduly formal sense unless expressly defined in the present application.

A vehicle air vent will be described in detail with reference to the accompanying drawings below. However, the same reference numerals will be assigned to the same or equivalent components regardless of drawing numbers, and repetitive descriptions will be omitted.

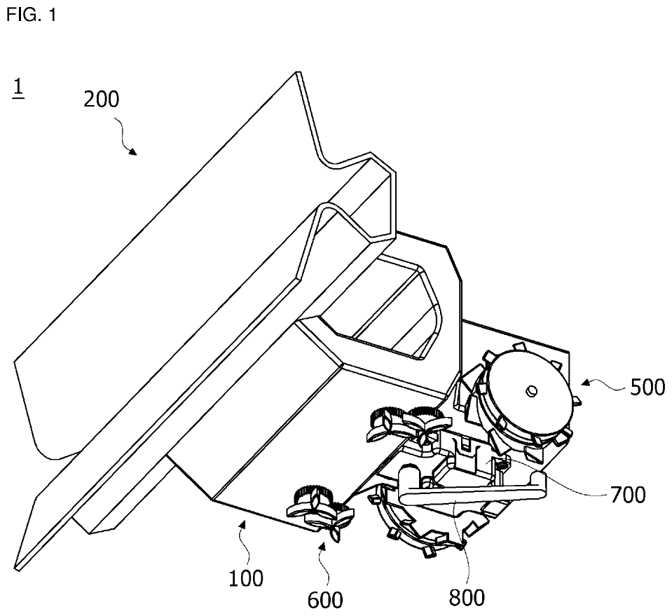

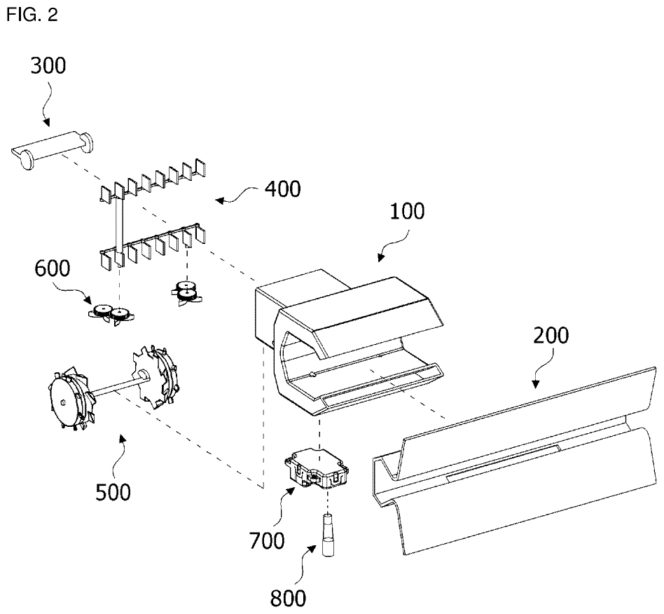

FIG. 1 is a perspective view of a vehicle air vent according to an embodiment of the present invention, and FIG. 2 is an exploded perspective view of the vehicle air vent.

FIGS. 1 and 2 show that the vehicle air vent 1 according to an embodiment of the present invention may be installed in the vehicle and guide air. More specifically, the vehicle air vent 1 may be connected to the air conditioning system and guide the air discharged from the air conditioning system toward the passenger cabin of the vehicle. The vehicle air bent 1 includes a housing 100, a garnish 200, a first wing assembly 300, a second wing assembly 400, a first control unit 500, a second control unit 600, an actuator 700, and a rotating member 800.

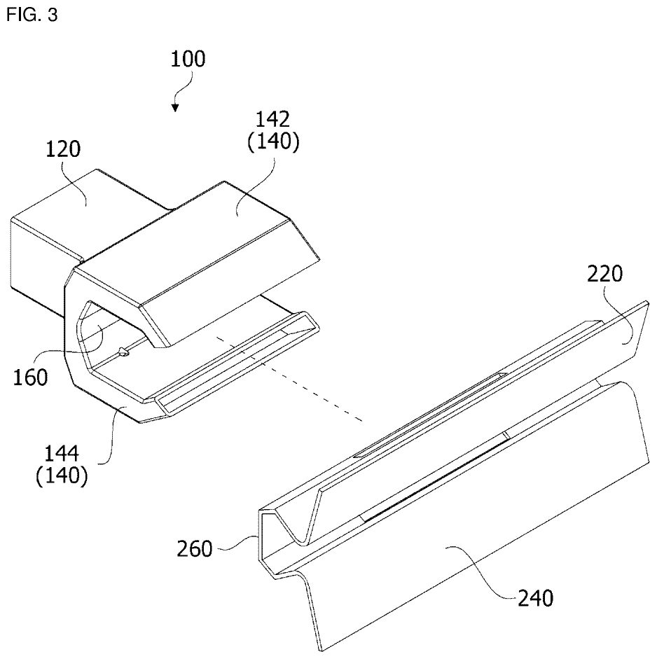

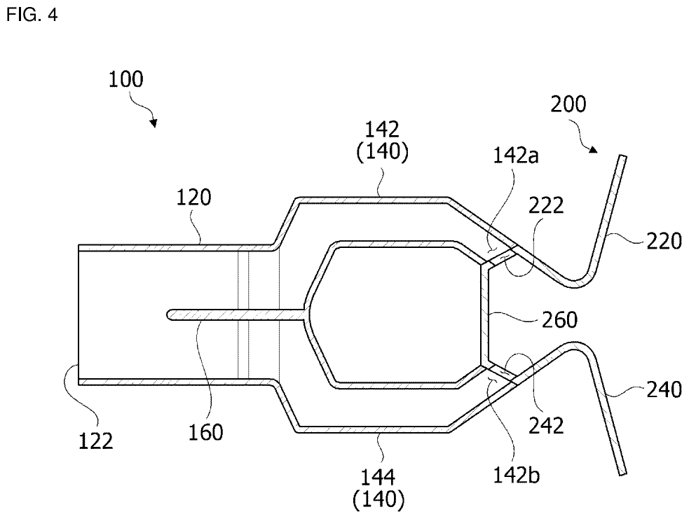

FIG. 3 is a view illustrating the housing and the garnish, and FIG. 4 is a cross-sectional view illustrating the inside of the housing and garnish in the state where the garnish is coupled to the housing.

FIGS. 1 to 4 show that the housing 100 may accommodate a first wing 320 and a second wing 420 to be described below and form a path for the air to flow through. The housing 100 may include an inlet portion 120, a guide portion 140, and a split portion 160. The housing 100 may be a thin-walled structure with a hollow interior designed to form a flow path for air.

The inlet portion 120 may be a portion where the air discharged from the air conditioning system enters the interior of the housing 100. The inlet portion 120 may have a cuboidal shape with one side and the other side open but is not limited thereto. An inlet hole 122 through which air enters may be formed on one open side of the inlet portion 120, and the split portion 160 may be disposed on the other open side of the inlet portion 120.

The guide portion 140 may guide air entering the inlet portion 120 toward the ceiling surface or floor surface of the passenger compartment. The guide portion 140 may include a first guide portion 142 and a second guide portion 144.

The first guide portion 142 may be disposed above the split portion 160 with respect to the split portion 160. The first guide portion 142 may have a shape with a start-end portion and a terminal-end portion slanted and disposed at a distance. As a result, as illustrated in FIG. 4, the air entering the first guide portion 142 may finally move toward a fourth guide portion 240, to be described below, of the garnish 200. In addition, the first guide portion 142 may be connected to the inlet portion 120. As a result, the air passing through the inlet portion 120 may move toward the floor surface of the passenger compartment through the first guide portion 142. The first guide portion 142 may include a first guide hole 142a. The first guide hole 142a may serve as an outlet for the air moving along the first guide portion 142.

The second guide portion 144 may be disposed under the split portion 160 with respect to the split portion 160. The second guide portion 144 may have a shape with a start-end portion and a terminal-end portion slanted and disposed at a distance. Here, the second guide portion 144 may have a shape symmetric to the first guide portion 142. As a result, as illustrated in FIG. 4, the air entering the second guide portion 144 may ultimately move toward a third guide portion 220, to be described below, of the garnish 200. In addition, the second guide portion 144 may be connected to the inlet portion 120. As a result, the air entering the inlet portion 120 may move toward the ceiling surface of the passenger compartment through the second guide portion 144. The second guide portion 144 may include a second guide hole 144a. The second guide hole 144a may serve as an outlet for the air moving along the second guide portion 144.

The split portion 160 may be disposed between the first guide portion 142 and the second guide portion 144 of the guide portion 140. The split portion 160 may be disposed parallel to the inlet portion 120. The split portion 160 may have a shape protruding from the guide portion 140 toward the inlet hole 122 of the inlet portion 120. The split portion 160 may compartmentalize the interior space of the inlet portion 120. When the moving direction of the air passing through the inlet portion 120 is determined by the first wing 320, the split portion 160 may guide the air toward the first guide portion 142 or the second guide portion 144 of the guide portion 140.

The garnish 200 may be coupled to the housing 100. More specifically, the garnish 200 may be disposed in a portion where the first guide hole 142a or the second guide hole 144a of the housing 100 is formed. The garnish 200 may include the third guide portion 220, the fourth guide portion 240, and a blocking portion 260.

The third guide portion 220 may be coupled to the first guide portion 142 of the housing 100. The third guide portion 220 may have a shape with a plurality of bends. The third guide portion 220 may guide the air passing through the first guide portion 142 of the housing 100. More specifically, the third guide portion 220 may guide air such that the air passing through the first guide portion 142 of the housing 100 moves toward the floor surface of the passenger compartment. The third guide portion 220 may include a third guide hole 222. When the third guide portion 220 is connected to the first guide portion 142 of the housing 100, the third guide hole 222 may communicate with the first guide hole 142a of the first guide portion 142 of the housing 100.

The fourth guide portion 240 may be coupled to the second guide portion 144 of the housing 100. The fourth guide portion 240 may have a shape with a plurality of bends. The guide portion 240 may have a shape symmetric to the third guide portion 220. The fourth guide portion 240 may guide the air passing through the second guide portion 144 of the housing 100. More specifically, the fourth guide portion 240 may guide air such that the air passing through the second guide portion 144 of the housing 100 moves toward the ceiling surface of the passenger compartment. The fourth guide portion 240 may include a fourth guide hole 242. Once the fourth guide portion 240 is connected to the second guide portion 144 of the housing 100, the fourth guide hole 242 may communicate with the second guide hole 144a of the second guide portion 144 of the housing 100.

The blocking portion 260 may be connected to the third guide portion 220 and the fourth guide portion 240. The blocking portion 260 may support the third guide portion 220 and the fourth guide portion 240. In addition, when the garnish 200 is coupled to the housing 100, the blocking portion 260 may be disposed at the location where the blocking portion 260 blocks the space formed by the first guide portion 142 and the second guide portion 144 of the housing 100. As a result, the blocking portion 260 may block a portion of the moving path of air such that the air passing through the first guide portion 142 or the second guide portion 144 of the housing 100 does not enter the space formed by the first guide portion 142 and the second guide portion 144 of the housing 100. As a result, the air volume loss may be prevented by the blocking portion 260.

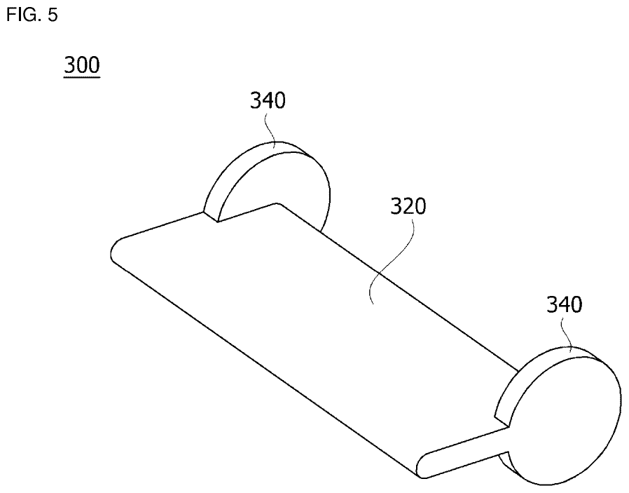

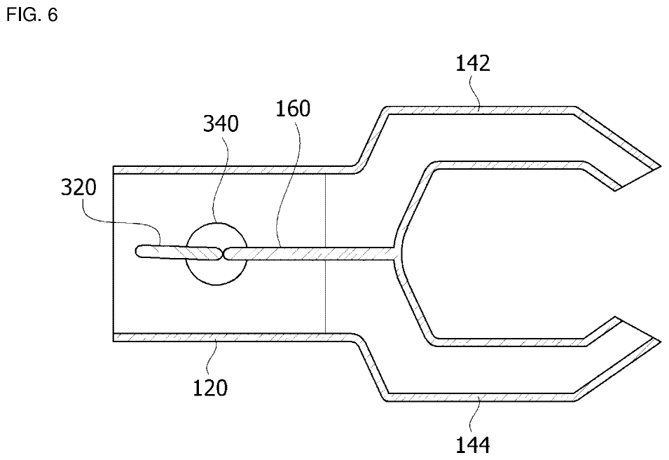

FIG. 5 is a perspective view of the first wing assembly, and FIG. 6 is a cross-sectional view of the first wing assembly coupled to the interior of the housing.

FIGS. 2, 5, and 6 show that the first wing assembly 300 may be disposed inside the inlet portion 120 of the housing 100. The first wing assembly 300 may include a first wing 320 and a first connecting block 340.

The first wing 320 may guide air toward the ceiling surface or floor surface of the passenger compartment of the vehicle. The first wing 320 may be disposed in the direction crossing the moving direction of the air passing through the inlet portion 120 of the housing 100. The first wing 320 may have round-edged cuboidal shape. The first wing 320 may be disposed at a location close to the inlet hole 122 of the inlet portion 120 of the housing 100. As a result, the first wing 320 may guide air such that the air entering through the inlet portion 120 of the housing 100 may flow through the first guide portion 142 or the second guide portion 144, or both the first guide portion 142 and the second guide portion 144 of the housing 100 simultaneously. The first wing 320 is disposed behind the second wing 420, to be described below, in the airflow direction so that the first wing 320 may be referred to as a rear wing.

The first connecting block 340 may be coupled to the first wing 320. The connecting block 340 may be disposed at both ends of the first wing 320. The connecting block 340 may have a shape extending from the split portion 160 of the housing 100, in the state of being disposed at the inlet portion 120 of the housing 100. The first connecting block 340 may be rotatably coupled to the inlet portion 120 of the housing 100. In addition, the first connecting block 340 may be a rotation center of the first wing 320. As a result, the first connecting block 340 may rotate the first wing 320 in conjunction with the movement of a second connecting block 580 to be described below. Although not shown, the first connecting block 340 may have a shape engaging the second connecting block 580, to be described below, such as to be linked to the movement of the second connecting block 580.

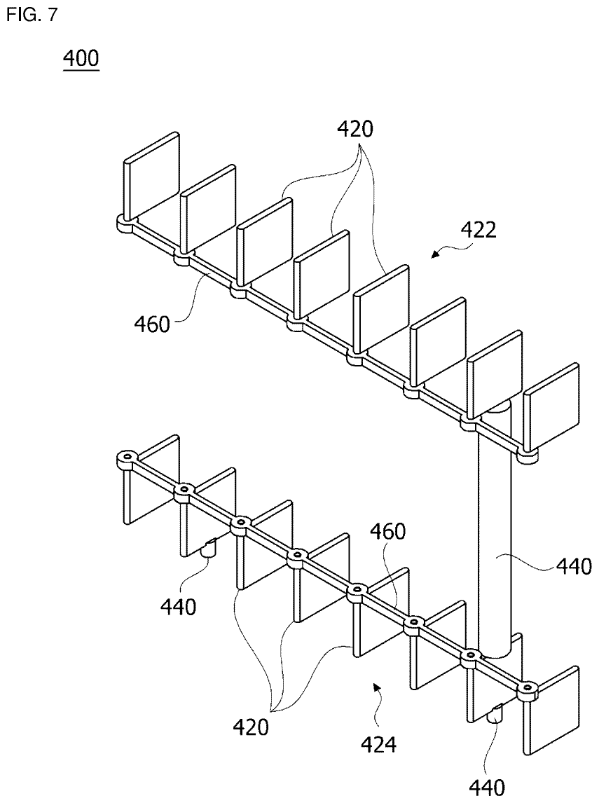

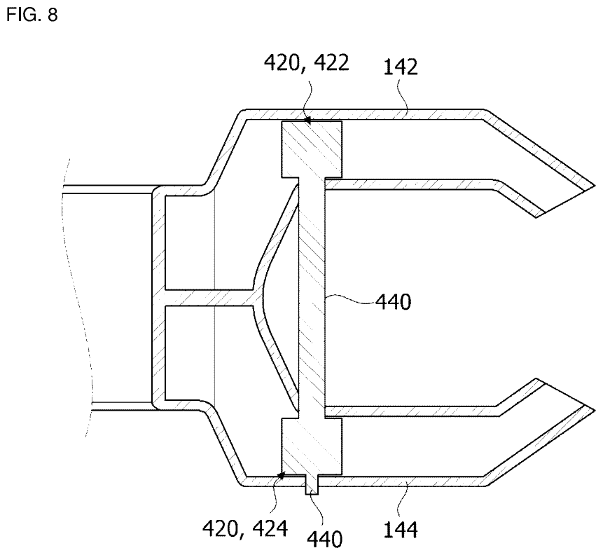

FIG. 7 is a perspective view of a second wing assembly, and FIG. 8 is a cross-sectional view illustrating the second wing assembly coupled to the interior of the housing.

FIGS. 2, 7, and 8 show that the second wing assembly 400 may be coupled to the housing 100. The second wing assembly 400 may guide the air entering the guide portion 140 of the housing 100. The second wing assembly 400 may include a second wing 420, a support block 440, and a union block 460.

The second wing 420 may guide air toward the side of the passenger compartment of the vehicle. A plurality of second wings 420 may be provided. The second wing 420 may include a 2-1 wing unit 422 and a 2-2 wing unit 424. The second wing 420 is disposed in front of the first wing 320 in the airflow direction so that the second wing 420 may be referred to as a front wing.

The 2-1 wing unit 422 may include a plurality of second wings 420 and may be disposed inside the first guide portion 142 of the guide portion 140 of the housing 100. The 2-1 wing unit 422 may be rotated by the support block 440 and the union block 460 inside the first guide portion 142 of the housing 100.

The 2-2 wing unit 424 may include a plurality of second wings 420 and may be disposed inside the second guide portion 144 of the guide portion 140 of the housing 100. The 2-2 wing unit 424 may be rotated by the support block 440 and the union block 460 inside the second guide portion 144 of the housing 100.

As illustrated in FIG. 7, the support block 440 may have a cylindrical shape. The support block 440 may connect any one of the plurality of second wings 420 that make up the 2-1 wing unit 422 to any one of the plurality of second wings 420 that make up the 2-2 wing unit 424. As illustrated in FIG. 8, the support block 440 may protrude to be exposed to the outside of the housing 100 in the connected state to the second wing 420. In addition, the support block 440 may be connected to a second control unit 600. As a result, the support block 440 may rotate in conjunction with the movement of the second control unit 600. Here, the support block 440 connects the 2-1 wing unit 422 and the 2-2 wing unit 424 so that the 2-1 wing unit 422 and the 2-2 wing unit 424 may simultaneously rotate in the same direction when the support block 440 rotates.

A plurality of union blocks 460 may be provided. The union block 460 may connect the plurality of second wings 420 that make up the 2-1 wing unit 422 and connect the plurality of second wings 420 that make up the 2-2 wing unit 424. In addition, the union block 460 may rotatably support the plurality of second wings 420 that make up the 2-1 wing unit 422 and rotatably support the plurality of second wings 420 that make up the 2-2 wing unit 424. As a result, the 2-1 wing unit 422 and the 2-2 wing unit 424 may simultaneously rotate in the same direction when the support block 440 rotates.

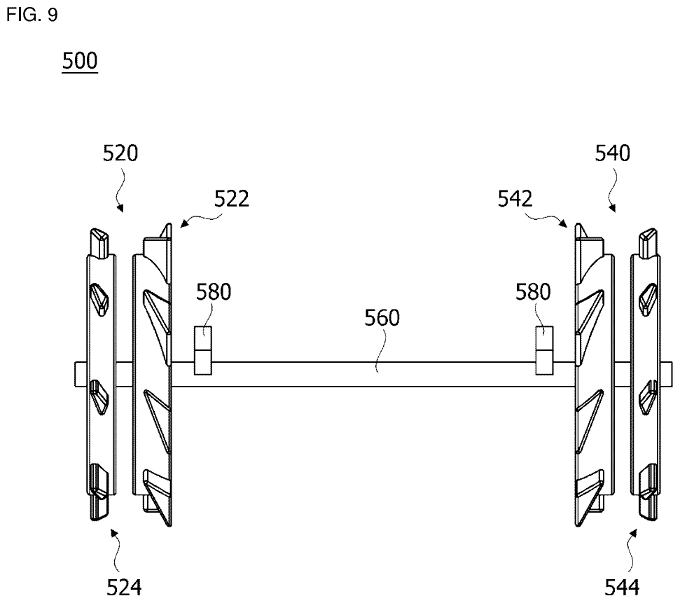

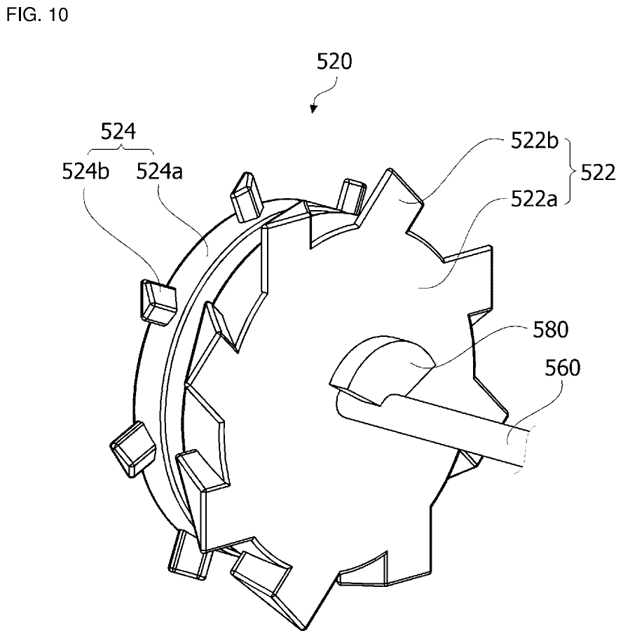

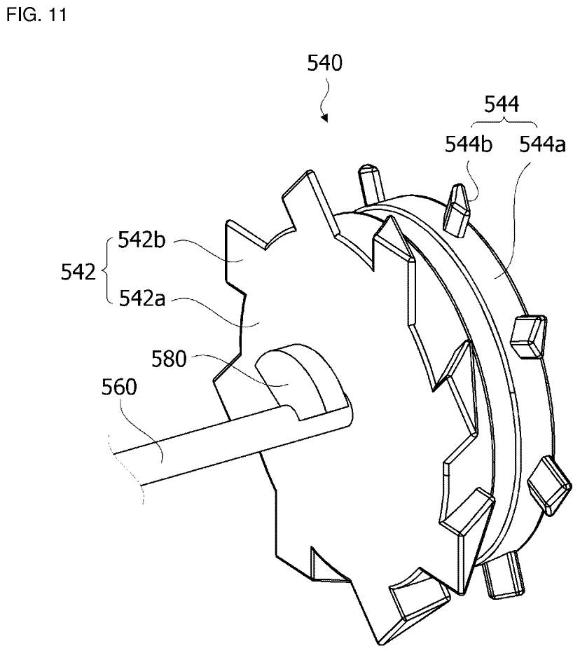

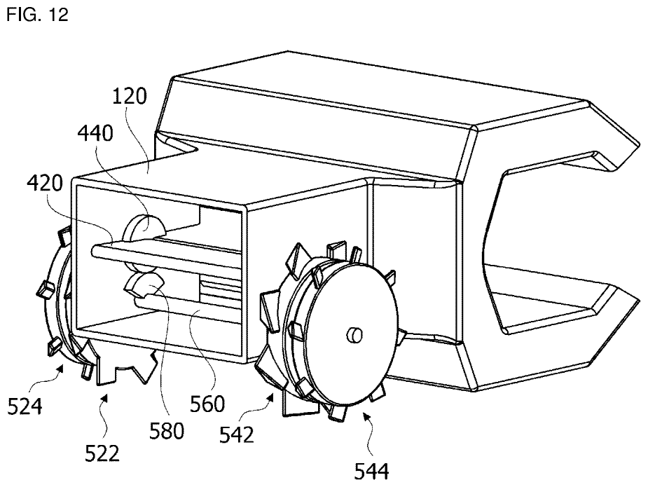

FIG. 9 is a front view of the first control unit, FIG. 10 is a perspective view illustrating the first gear unit, FIG. 11 is a perspective view illustrating the second gear unit, and FIG. 12 is a view illustrating a state in which the first connecting block of the first wing assembly and the second connecting block of the first control unit are in contact with each other inside the housing.

FIGS. 1, 2, and 9 to 12 show that the first control unit 500 is rotatably coupled to the housing 100 and may control the rotation direction and the rotation angle of the first wing 320 while rotating in conjunction with the rotation of the rotating member 800. The first control unit 500 may include a first gear unit 520, a second gear unit 540, a shaft 560, and the second connecting block 580.

The first gear unit 520 may rotate the first wing 320 upward while rotating in selective contact with the rotating member 800 reciprocating along a predetermined section. As illustrated in FIGS. 1 and 12, the first gear unit 520 may be disposed outside the housing 100. The first gear unit 520 may include a 1-1 gear 522 and a 1-2 gear 524.

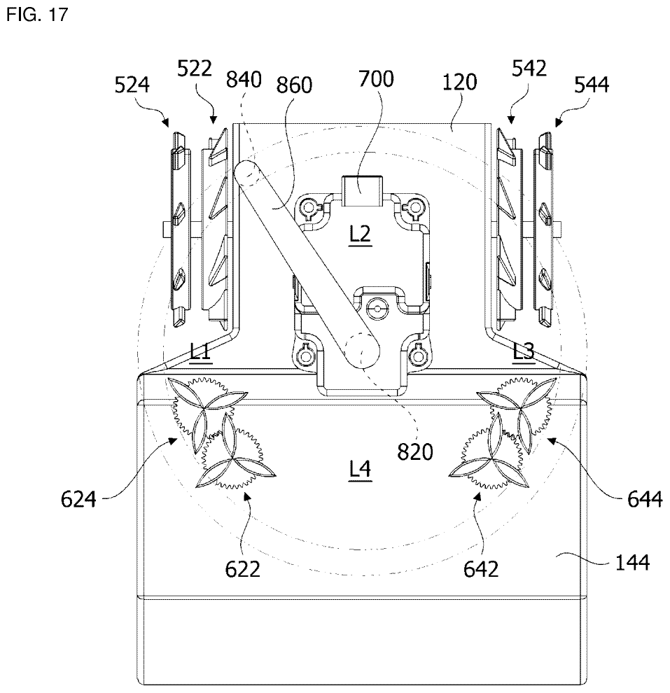

The 1-1 gear 522 may be disposed in the left-hand area of the shaft 560 in terms of FIG. 9. The 1-1 gear 522 may rotate in contact with the rotating member 800 rotating in the first rotation direction R1. Here, the first rotation direction R1 may refer to the clockwise direction when viewed from the bottom of the vehicle air vent 1 (see FIG. 17).

The 1-1 gear 522 may include a disk-shaped first plate portion 522a and plurality of first tooth portions 522b protruding from a side of the first plate portion 522a and disposed along the perimeter of the first plate portion 522a. Here, the plurality of first tooth portions 522b may be disposed at an equal distance from each other. The 1-1 gear 522 may be disposed close to the outer surface of the housing 100. In addition, each first tooth portion 522b may have a slanted surface that comes into contact with the rotating member 800.

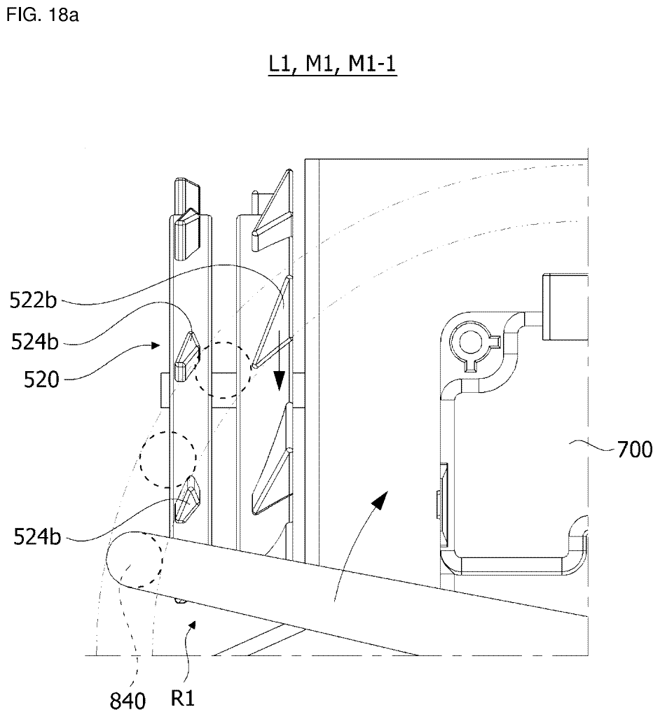

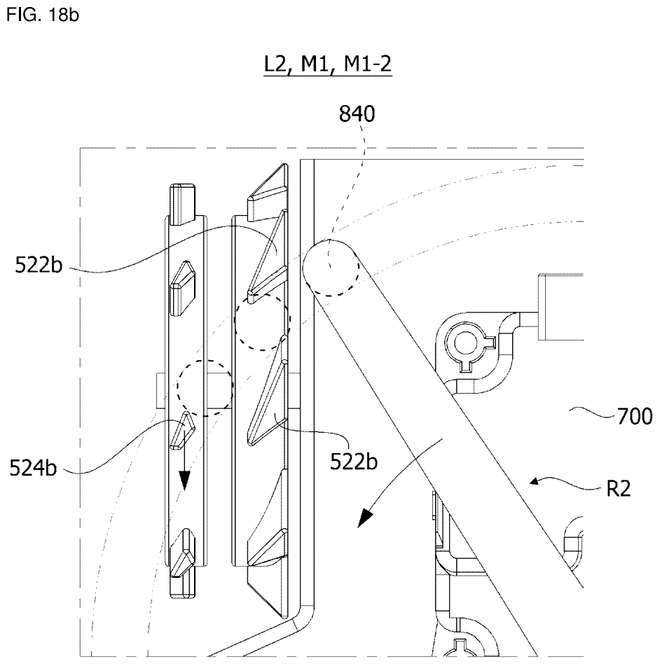

The 1-2 gear 524 may be disposed in the left-hand area of the shaft 560 in terms of FIG. 9. The 1-2 gear may be disposed at a location farther away than the 1-1 gear 522 is from the housing 100. The 1-2 gear 524 may be disposed at a distance from the 1-1 gear 522 in the direction in which the shaft 560 is disposed. The 1-2 gear 524 may rotate in contact with the rotating member 800 rotating in the second rotation direction R2. Here, the second rotation direction R2 may refer to the counterclockwise direction when viewed from the bottom of the vehicle air vent 1 (see FIGS. 18 to 25).

The 1-2 gear 524 may include a disk-shaped second plate portion 524a and a plurality of second tooth portions 524b protruding from the side of the second plate portion 524a and disposed along the circumference of the second plate portion 524a. Here, the plurality of second tooth portions 524b may have a shape different from the shape of the plurality of first tooth portions 522b of the 1-1 gear 522. In addition, each second tooth portion 524b may have a slanted surface that comes into contact with the rotating member 800.

The second gear unit 540 may rotate the first wing 320 downward while rotating in selective contact with the rotating member 800 reciprocating along a predetermined section. As illustrated in FIGS. 1 and 12, the second gear unit 540 may be disposed outside the housing 100. The second gear unit 540 may include a 2-1 gear 542 and a 2-2 gear 544.

The 2-1 gear 542 may be disposed in the right-hand area of the shaft 560 in terms of FIG. 9. The 2-1 gear 542 may rotate in contact with the rotating member 800 rotating in the second rotation direction R2 (see FIGS. 18 to 25).

The 2-1 gear 542 may include a disk-shaped third plate portion 542a and a plurality of third tooth portions 542b protruding from a side of the third plate portion 542a and disposed along the circumference of the third plate portion 542a. Here, the plurality of third tooth portion 542b may be disposed at an equal distance. The 2-1 gear 542 may be disposed close to the outer surface of the housing 100. In addition, each third tooth portion 542b may have a slanted surface that comes into contact with the rotating member 800.

The 2-2 gear 544 may be disposed in the right-hand area of the shaft 560 in terms of FIG. 9. The 2-2 gear may be disposed at a location farther away than the 2-1 gear 542 is from the housing 100. The 2-2 gear 544 may be disposed at a distance from the 2-1 gear 542 in the direction in which the shaft 560 is disposed. The 2-2 gear 544 may rotate in contact with the rotating member 800 rotating in the first rotation direction R1 (see FIG. 17).

The 2-2 gear 544 may include a disk-shaped fourth plate portion 544a and a plurality of fourth tooth portions 544b protruding from the side of the fourth plate portion 544a and disposed along the circumference of the fourth plate portion 544a. Here, the plurality of fourth tooth portion 544b may have a shape different from the shape of the plurality of third tooth portions 542b of the 2-1 gear 542. In addition, each fourth tooth portion 544b may have a slanted surface that comes into contact with the rotating member 800.

As illustrated in FIG. 9, the 1-1 gear 522 and 2-1 gear 542 may have a shape symmetric to each other, and the 1-2 gear 524 and 2-2 gear 544 may have a shape symmetric to each other. This may create the effect of causing the first wing 320 rotating in conjunction with the first control unit 500 to have an equal rotation distance. As a result, the need for an additional device to ensure that the first wing 320 has an equal distance is eliminated. More specifically, the need for a sensor such as an encoder for measuring the rotation distance may be eliminated. As a result, the cost of providing the sensor may be saved.

The shaft 560 may connect the first gear unit 520 and the second gear unit 540. The shaft 560 may be provided in a cylindrical shape. In addition, the shaft 560 may support the second connecting block 580. This shaft 560 may be rotatably coupled to the housing 100. Here, the shaft 560 may be disposed in the inlet portion 120 of the housing 100 such that both ends protrude to the outside of the housing 100. This shaft 560 may serve as the rotation center for the first gear unit 520, the second gear unit 540, and the second connecting block 580

The second connecting block 580 may be coupled to the shaft 560 and disposed inside the housing 100. The second connecting block 580 may be disposed on both end portions of the shaft 560. The connecting block 580 may be provided in a fan-shaped configuration.

The second connecting block 580 may engage the first connecting block 340, in the state of being disposed inside the housing 100 As a result, the first wing 320 and the first connecting block 340 of the first wing assembly 300 may rotate in the direction opposite the rotation direction of the second connecting block 580 while rotating in conjunction with the rotation of the second connecting block 580 of the first control unit 500. In other words, the second connecting block 580 may deliver to the first wing assembly 300 a driving force that enables the first wing assembly 300 to rotate. Although not illustrated, the second connecting block 580 may have a shape engaging the first connecting block 340 such that conjunction with the movement of the first connecting block 340 is made possible.

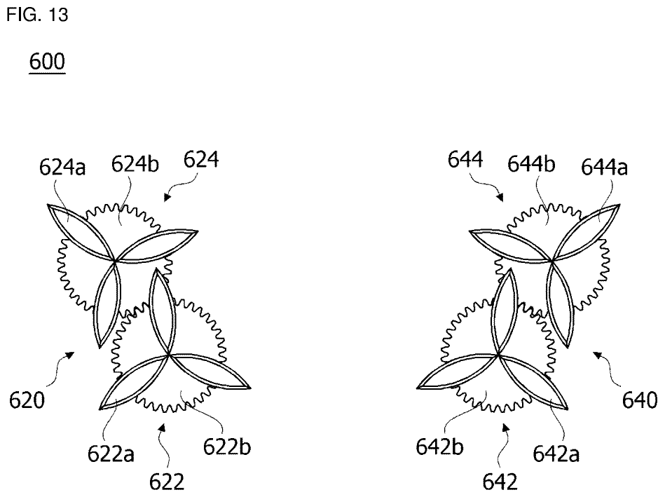

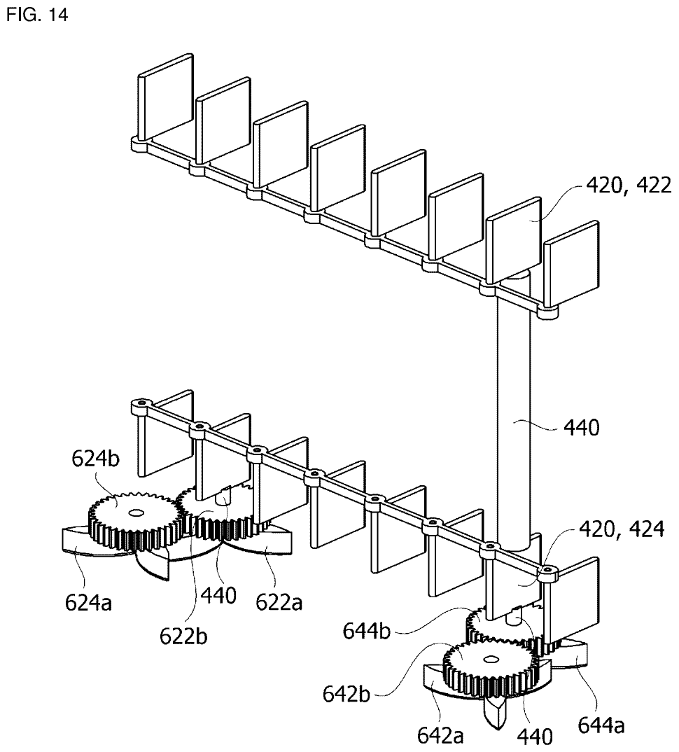

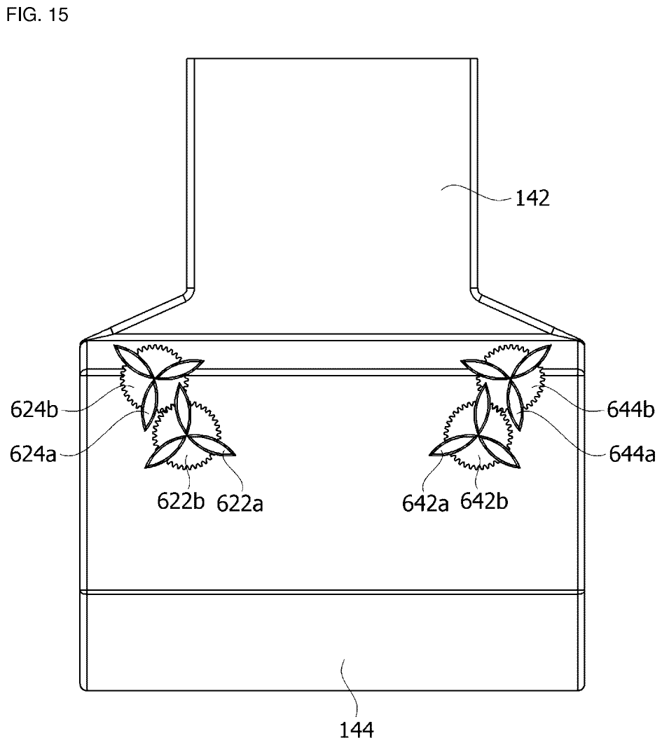

FIG. 13 is a view illustrating the second control unit, FIG. 14 is a view illustrating the second control unit coupled to the second wing assembly, and FIG. 15 is a view illustrating the second control unit disposed outside the housing.

FIGS. 1, 2, and 13 to 15 show that the second control unit 600 may be disposed outside the housing 100 and control the rotation direction and rotation angle of the second wing 420 while rotating in conjunction with the rotation of the rotating member 800. The second control unit 600 may include a third gear unit 620 and a fourth gear unit 640.

The third gear unit 620 may rotate the second wing 420 in one direction while rotating in selective contact with the rotating member 800 reciprocating along a predetermined section. The third gear unit 620 may include a 3a gear unit 622 and a 3b gear unit 624.

The 3a gear unit 622 may include a 3-1 gear 622a rotating in selective contact along with the rotating member 800 rotating in a second rotation direction R2 and a 3-2 gear 622b coupled to the 3-1 gear 622a and any one of the plurality of second wings 420.

The 3-1 gear 622a may be a combination of a plurality of blocks. The 3-1 gear 622a may be disposed such that one end of the plurality of blocks meets each other. In the present embodiment, the 3-1 gear 622a is presented as a combination of three blocks but is not limited thereto.

The 3-2 gear 622b may be disposed on the 3-1 gear 622a. The 3-2 gear 622b may be provided in the shape of gear teeth having convex and concave portions alternating on the side of a circular plate. The 3-2 gear 622b may be coupled to a support block 440 of the second wing assembly 400. As a result, when the 3-1 gear 622a is rotated by the rotating member 800, the 3-2 gear 622b may rotate along with the 3-1 gear 622a and the support block 440 of the second wing assembly 400 may rotate along with the 3-2 gear 622b. More specifically, when the 3-2 gear 622b rotates, the support block 440 of the second wing assembly 400 coupled to the 3-2 gear 622b, any one of the plurality of second wings 420 forming the 2-2 wing unit 424, and any one of the plurality of second wings 420 forming the 2-1 wing unit 422 may rotate.

The 3b gear unit 624 may include a 3-3 gear 624a coming into contact with the rotating member 800 rotating in the first rotation direction R1 and a 3-4 gear 624b coupled to the 3-3 gear 624a and rotatably coupled to the housing 100.

The 3-3 gear 624a may be a combination of a plurality of blocks. The 3-3 gear 624a may be disposed such that one end of the plurality of blocks meets each other. In the present embodiment, the 3-3 gear 624a is presented as a combination of three blocks but is not limited thereto.

The 3-4 gear 624b may be disposed on the 3-3 gear 624a. The 3-4 gear 624b may be provided in the shape of gear teeth having convex and concave portions alternating on the side of a circular plate. The 3-4 gear 624b may engage the 3-2 gear 622b. Thereby, when the 3-3 gear 624a is rotated by the rotating member 800, the 3-4 gear 624b may rotate the 3-2 gear 622b while rotating along with the 3-3 gear 624a. In contrast, when the 3-1 gear 622a is rotated by the rotating member 800, the 3-2 gear 622b may rotate the 3-4 gear 624b while rotating along with the 3-1 gear 622a.

The fourth gear unit 640 rotates the second wing 420 in the other direction opposite one direction while rotating in selective contact with the rotating member 800 reciprocating along a predetermined section. The fourth gear unit 640 may include a 4b gear unit 642 and a 4b gear unit 644.

The 4a gear unit 642 may include a 4-1 gear 642a rotating in contact with the rotating member 800 rotating in the first rotation direction R1 and a 4-2 gear 642b coupled to the 4-1 gear 642a and coupled to any one of the plurality of second wings 420.

The 4-1 gear 642a may be a combination of a plurality of blocks. The 4-1 gear 642a may be disposed such that one end of the plurality of block meets each other. In the present embodiment, the 4-1 gear 642a is presented as a combination of three blocks but is not limited thereto.

The 4-2 gear 642b may be disposed on the 4-1 gear 642a. The 4-2 gear 642b may be provided in the shape of gear teeth having convex and concave portions alternating on the side of a circular plate. The 4-2 gear 642b may be coupled to the support block 440 of the second wing assembly 400. As a result, when the 4-1 gear 642a is rotated by the rotating member 800, the 4-2 gear 642b may rotate along with the 4-1 gear 642a, and the support block 440 of the second wing assembly 400 may rotate along with the 4-2 gear 642b. More specifically, when the 4-2 gear 642b rotates, the support block 440 of the second wing assembly 400 coupled to the 4-2 gear 642b, any one of the plurality of second wings 420 forming the 2-2 wing unit 424, and any one of the plurality of second wings 420 forming the 2-1 wing unit 422 may rotate.

The 4b gear unit 644 may include a 4-3 gear 644a coming into contact with the rotating member 800 rotating in the second rotation direction R2 and a 4-4 gear 644b coupled to the 4-3 gear 644a and rotatably coupled to the housing 100.

The 4-3 gear 644a may be a combination of a plurality of blocks. The 4-3 gear 644a may be disposed such that one end of the plurality of blocks meets each other. In the present embodiment, the 4-3 gear 644a is presented as a combination of three blocks but is not limited thereto.

The 4-4 gear 644b may be disposed on the 4-3 gear 644a. The 4-4 gear 644b may be provided in the shape of gear teeth having convex and concave portions alternating on the side of a circular plate. The 4-4 gear 644b may engage the 4-2 gear 642b. Thereby, when the 4-3 gear 644a is rotated by the rotating member 800, the 4-4 gear 644b may rotate the 4-2 gear 642b while rotating along with the 4-3 gear 644a. In contrast, when the 4-1 gear 642a is rotated by the rotating member 800, the 4-2 gear 642b may rotate the 4-4 gear 644b while rotating along with the 4-1 gear 642a.

The third gear unit 620 and the fourth gear unit 640 of the second control unit 600 may be collinearly disposed (see FIG. 15). More specifically, the 3a gear unit 622 of the third gear unit 620 and the 4a gear unit 642 of the fourth gear unit 640 may be collinearly disposed, and the 3b gear unit 624 of the third gear unit 620 and the 4b gear unit 644 of the fourth gear unit 640 may be collinearly disposed.

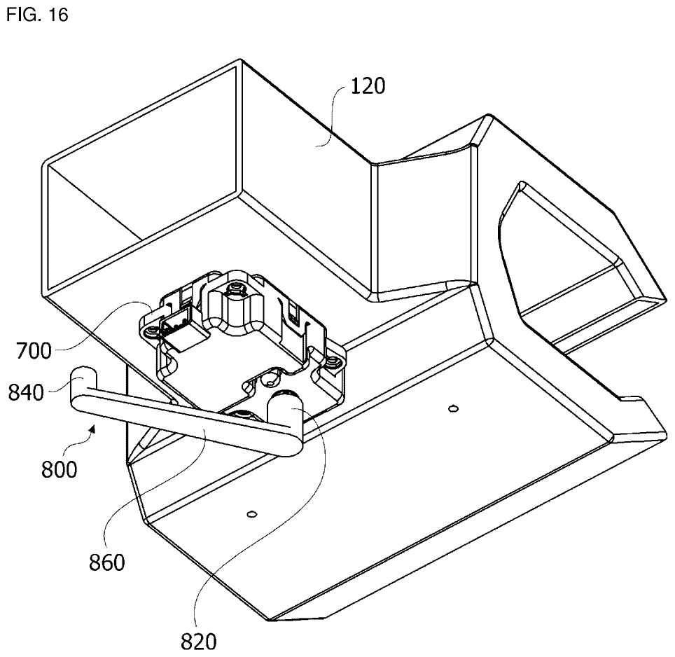

FIG. 16 is a view illustrating the actuator and the rotating member disposed outside the housing, and FIG. 17 is a view illustrating a disposition relationship between the first control unit, the second control unit, the actuator, and the rotating member.

FIGS. 1, 2, 16, and 17 show that the actuator 700 may be disposed between the first wing assembly 300 and the second wing assembly 400. The actuator 700 may be connected to an external power source device to receive power. The actuator 700 may produce a mechanical force upon receiving power. A processor or controller (not shown) may control the actuator 700 to actuate the first wing assembly 300 and the second wing assembly 400 to control air flow in the passenger compartment, based on user preference(s).

The rotating member 800 may be connected to the actuator 700 and operate the first wing 320 and the second wing 420 while being rotated by the mechanical force generated by the actuator 700. The rotating member 800 may include a coupling portion 820 coupled to the actuator 700 to rotate by the mechanical force generated by the actuator 700, a contact portion 840 disposed at a distance from the coupling portion 820 and coming into contact with the first control unit 500 or the second control unit 600 while rotating in conjunction with the rotation of the coupling portion 820, and a body portion 860 disposed between the coupling portion 820 and the contact portion 840 to connect the coupling portion 820 and the contact portion 840.

The actuator 700 and the rotating member 800 may be disposed outside the housing 100. In other words, in the vehicle air vent 1 of the present invention, the configurations other than the portion that directly guides the air are disposed outside the housing 100 so that the internal area of the housing 100 available for airflow is not reduced, thereby preventing a loss of airflow.

FIG. 17 shows that the first control unit 500 and the second control unit 600 may be disposed on the rotation path of the rotating member 800. As a result, the need for additional configurations for operating the first control unit 500 or the second control unit 600 may be eliminated. In addition, the first control unit 500 and the second control unit 600 may be disposed on the rotation path of the rotating member 800 so that the rotation force of the rotating member 800 may be converted into a driving force for operating the first wing 320 or the second wing 420. As a result, the need for configurations that require the user's manual force, such as knobs used in conventional air vents, is eliminated, thereby improving the user's convenience in using the air vent.

In the following, the process in which the vehicle air vent according to an embodiment of the present invention guides air will be described.

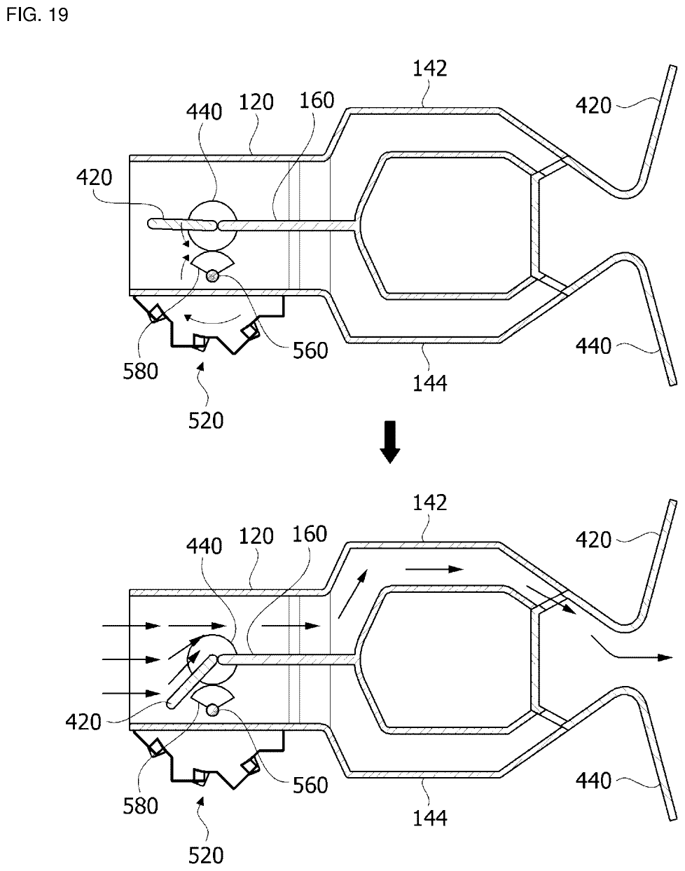

FIG. 18a is a view illustrating a process of the rotating member coming into contact with the 1-1 gear of the first control unit, FIG. 18b is a view illustrating a process of the rotating member coming into contact with the 1-2 gear of the first control unit, and FIG. 19 is a view illustrating a moving path of air toward the second guide portion of the housing by the rotation of the first wing.

In the following description, a first location L1 to a fourth location L4 to be shown in FIGS. 17 and 18a and the following diagrams refer to the location at which the rotating member 800 is disposed. The first location L1 may be a space between the first gear unit 520 of the first control unit 500 and the third gear unit 620 of the second control unit 600. The second location L2 may be a space between the first gear unit 520 and the second gear unit 540 of the first control unit 500. The third location L3 may be a space between the second gear unit 540 of the first control unit 500 and the fourth gear unit 640 of the second control unit 600. The fourth location L4 may be a space between the third gear unit 620 and the fourth gear unit 640 of the second control unit 600.

FIGS. 17 and 18a to 19 show that the first wing 320 may rotate to guide the air toward the second guide portion 144 of the housing 100 as the first gear unit 520 of the first control unit 500 is rotated by the rotation of the rotating member 800. In the following, as illustrated in FIGS. 17, 18a, and 18b, the vehicle air vent 1 according to the present embodiment will be described as viewed from below.

First, as illustrated in FIG. 19, in a state where the rotating member 800 is yet to perform a first motion M1 to be described below, the first wing 320 remains parallel to the split portion 160 of the housing 100.

In addition, in this state, as illustrated in FIGS. 17 and 18a, the rotating member 800 is disposed at the first location L1. In addition, the rotating member 800 may rotate around the forth gear unit 640 and the third gear unit 620 to be disposed at the first location L1. This is because the second wing 420 may maintain the disposition direction parallel to the airflow direction without being disposed to deviate right or left when the rotating member 800 once passes the third gear unit 620 and the forth gear unit 640 having rotation centers parallel to the rotating member 800 and having symmetric shapes to each other. As a result, since the rotating member 800 passes the forth gear unit 640 and the third gear unit 620 once, the unintended setting of airflow direction by the unrequired rotation of the second wing 420 may be avoided when the first wing 320 is required to rotate.

In such a state, the actuator 700 may generate a mechanical force for operating the rotating member 800 such that the rotating member 800 may perform the first motion M1 when a motion signal is delivered to the actuator 700. Here, the first motion M1 is a reciprocating motion of the rotating member 800, and the first motion M1 may be divided into a 1-1 motion M1-1 and a 1-2 motion M1-2.

The 1-1 motion M1-1 is a motion by which the rotating member 800 rotates to switch from the first location L1 to a second location L2, and, as illustrated in FIG. 18a, the contact portion 840 of the rotating member 800 passes between the plurality of second tooth portions 524b of the 1-2 gear 524 of the first control unit 500 in the course of the 1-1 motion M1-1.

The rotating member 800 passing between the plurality of second tooth portions 524b of the 1-2 gear 524 comes into contact with the first tooth portion 522b of the 1-1 gar 522 of the first control unit 500. More specifically, the rotating member 800 passing between the plurality of second tooth portions 524b of the 1-2 gear 524 comes into contact with the slanted surface of the first tooth portion 522b of the 1-1 gear 522. Here the slanted surface of the first tooth portion 522b of the 1-1 gear 522 is rotated downward by the rotation force of the rotating member 800 in terms of FIGS. 18a and 19.

Thereby, the shaft 560 and the second connecting block 580, connected to the 1-1 gear 522, of the first gear unit 520 rotate downward along with the 1-1 gear 522. At this time, the second connecting block 580 is engagingly connected to the first connecting block 340 of the first wing assembly 300. As a result, when the second connecting block 580 rotates downward, the first connecting block 340 rotates upward. Thereby, as illustrated in FIG. 19, the first wing 320 connected to the first connecting block 340 also rotates upward.

In the course of the 1-1 motion M1-1, the rotating member 800 is disposed at the second location L2 after the contact with the first tooth portion 522b of the 1-1 gear 522 is terminated. Thereby, the 1-1 motion M1-1 is terminated. In the state where the 1-1 motion M1-1 is terminated, as illustrated in FIG. 18b, the first tooth portion 522b of the 1-1 gear 522 is disposed outside the rotation path of the rotating member 800, and the second tooth portion 524b of the 1-2 gear 524 is disposed on the rotation path of the rotating member 800. As a result, the rotating member 800 falls into a state where the rotating member 800 may pass between the plurality of first tooth portions 522b of the 1-1 gear 522.

The actuator 700 causes the rotating member 800 to perform a 1-2 motion M1-2 after the 1-1 motion M1-1 is terminated. The 1-2 motion M1-2 is a motion by which the rotating member 800 rotates to switch from the second location L2 to the first location L1, and as illustrated in FIG. 18b, the contact portion 840 of the rotating member 800 in the course of the 1-2 motion M1-2 passes between the plurality of first tooth portions 522b of the 1-1 gear 522 of the first control unit 500.

The rotating member 800 passing between the plurality of first tooth portions 522b of the 1-1 gear 522 comes into contact with the second tooth portion 524b of the 1-2 gear 524 of the first control unit 500. More specifically, the rotating member 800 passing between the plurality of first tooth portions 522b of the 1-1 gear 522 comes into contact with the slanted surface of the second tooth portion 524b of the 1-2 gear 524. Here, the slanted surface of the second tooth portion 524b of the 1-2 gear 524 is rotated downward by the rotation force of the rotating member 800 in terms of FIGS. 18b and 19.

As a result, the shaft 560 and the second connecting block 580, connected to the 1-1 gear 522, of the first gear unit 520 rotate downward along with the 1-1 gear 522. At this time, the second connecting block 580 is engagingly connected to the first connecting block 340 of the first wing assembly 300. As a result, when the second connecting block 580 rotates downward, the first connecting block 340 rotates upward. Thereby, the first wing 320 connected to the first connecting block 340 also rotates upward.

In the course of the 1-2 motion M1-2, the rotating member 800 is disposed at the first location L1 after the contact with the second tooth portion 524b of the 1-2 gear 524 is terminated. Thereby, the first motion M1 including the 1-2 motion M1-2 is terminated.

As illustrated in FIG. 19, the first wing 320 may close the upper space of the inlet portion 120 of the housing 100 while simultaneously guiding the air entering the housing 100 into the lower space of the inlet portion 120 of the housing 100. The air guided into the lower space of the inlet portion 120 of the housing 100 may move through the second guide portion 144 of the housing 100, and the air passing through a second guide hole 144a of the housing 100 and the fourth guide hole 242 of the garnish 200 may be guided through the fourth guide portion 240 of the garnish 200 to move finally toward the ceiling surface of the passenger compartment of the vehicle.

In this way, the rotating member 800 may rotate the first wing 320 by ¼ of 90° as the actuator 700 causes the rotating member 800 to perform the first motion M1. When this process is repeated four times, as illustrated in FIG. 19, the first wing 320 may fully close the upper space of the inlet portion 120 of the housing 100. In the vehicle air vent 1 according to an embodiment of the present invention, the actuator 700 may be set such that the rotating member 800 rotates as many times as set in a control portion (not shown) of the vehicle in addition to repeating the first motion M1 four times.

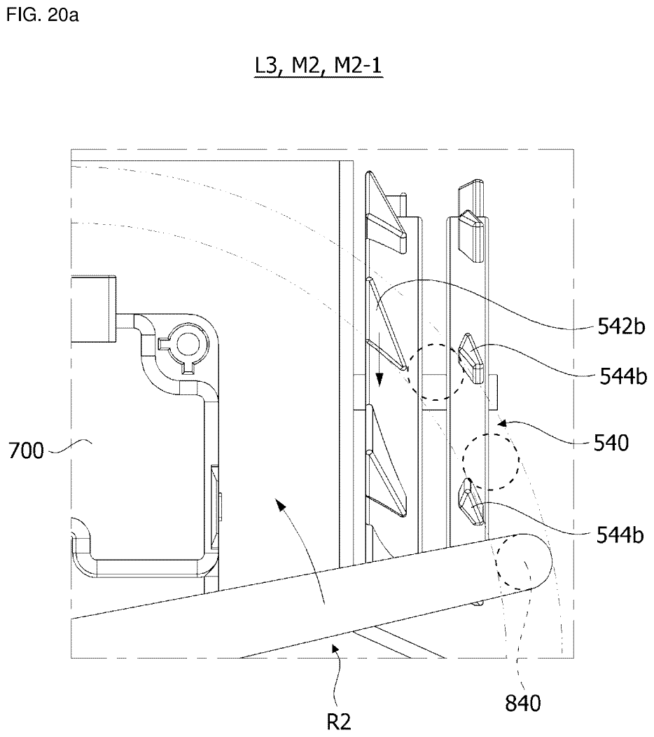

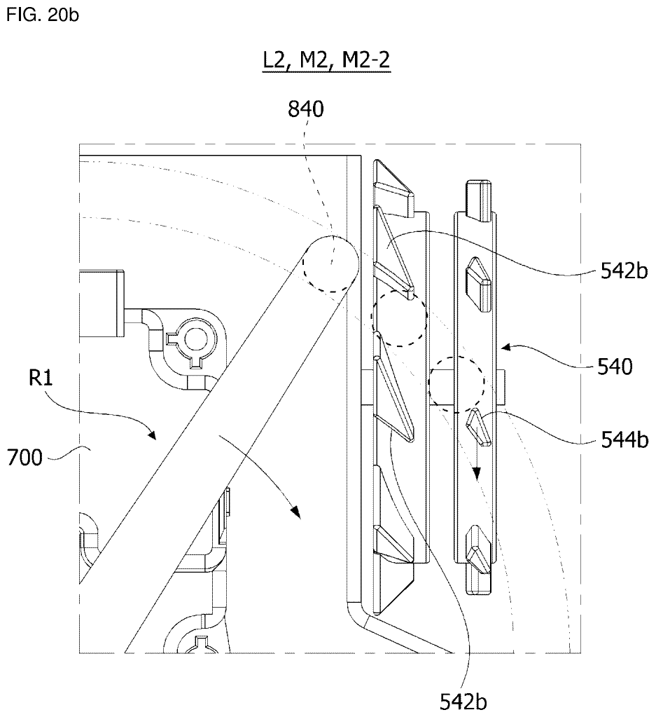

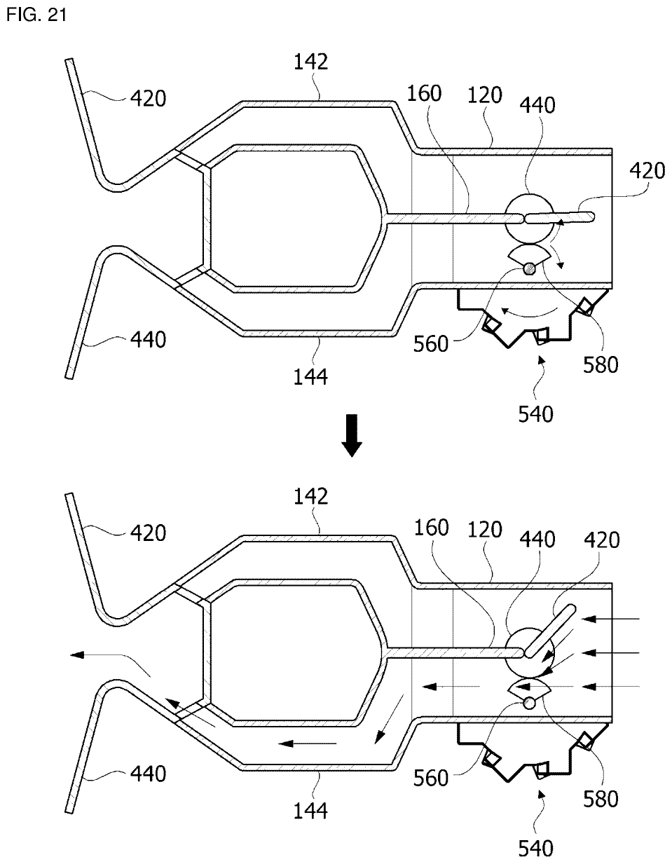

FIG. 20a is a view illustrating a process of the rotating member coming into contact with the 2-1 gear of the first control unit, FIG. 20b is a view illustrating a process of the rotating member coming into contact with the 2-2 gear of the first control unit, and FIG. 21 is a view illustrating a moving path of air toward the first guide portion of the housing by the rotation of the first wing.

Next, FIGS. 17 and 20a to 21 show that the first wing 320 may rotate to guide air toward the first guide portion 142 of the housing 100 as the second gear unit 540 of the first control unit 500 is rotated by the rotation of the rotating member 800. In the following, as illustrated in FIGS. 17, 20a, and 20b, the vehicle air vent 1 according to the present embodiment will be described as viewed from below.

First, as illustrated in FIG. 21, in a state where the rotating member 800 is yet to perform a second motion M2 to be described below, the first wing 320 remains parallel to the split portion 160 of the housing 100.

In addition, in this state, as illustrated in FIG. 18a, the rotating member 800 is disposed at the third location L3. In addition, the rotating member 800 may rotate around the third control unit and the second control unit 600 to be disposed at the third location L3.

In this state, the actuator 700 may generate a mechanical force for operating the rotating member 800 such that the rotating member 800 may perform the second motion M2 when a motion signal is delivered to the actuator 700. Here, the second motion M2 is a reciprocating motion of the rotating member 800, and the second motion M2 may be divided into a 2-1 motion M2-1 and a 2-2 motion M2-2.

The 2-1 motion M2-1 is a motion by which the rotating member 800 rotates to switch from the third location L3 to the second location L2, and, as illustrated in FIG. 20a, the contact portion 840 of the rotating member 800 in the course of the 2-1 motion M2-1 passes between the plurality of fourth tooth portions 544b of the 2-2 gear 544 of the first control unit 500.

The rotating member 800 passing between the plurality of fourth tooth portion 544b of the 2-2 gear 544 comes into contact with the third tooth portion 542b of the 2-1 gear 542 of the first control unit 500. More specifically, the rotating member 800 passing between the plurality of fourth tooth portions 544b of the 2-2 gear 544 comes into contact with the slanted surface of the third tooth portion 542b of the 2-1 gear 542. Here, the slanted surface of the third tooth portion 542b of the 2-1 gear 542 is rotated upward by the rotation force of the rotating member 800 in terms of FIGS. 21a and 21.

Thereby, the shaft 560 and the second connecting block 580, connected to the 2-1 gear 542, of the first gear unit 520 rotate upward along with the 2-1 gear 542. At this time, the second connecting block 580 is engagingly connected to the first connecting block 340 of the first wing assembly 300. As a result, when the second connecting block 580 rotates upward, the first connecting block 340 rotates downward. Thereby, as illustrated in FIG. 21, the first wing 320 connected to the first connecting block 340 also rotates downward.

The rotating member 800, of which the contact with the first tooth portion 522b of the 1-1 gear 522 is terminated, is disposed at the second location L2 in the course of the 2-1 motion M2-1 as described above. Thereby, the 2-1 motion M2-1 is terminated. In the state where the 2-1 motion M2-1 is terminated, as illustrated in FIG. 20b, the third tooth portion 542b of the 2-1 gear 542 is disposed outside the rotation path of the rotating member 800, and the fourth tooth portion 544b of the 2-2 gear 544 is disposed on the rotation path of the rotating member 800. As a result, the rotating member 800 falls into a state where the rotating member 800 may pass between the plurality of third tooth portions 542b of the 2-1 gear 542.

The actuator 700 causes the rotating member 800 to perform a 2-2 motion M2-2 after the 2-1 motion M2-1 is terminated. The 2-2 motion M2-2 is a motion by which the rotating member 800 rotates to switch from the second location L2 to the third location L3, and, as illustrated in FIG. 20b, the contact portion 840 of the rotating member 800 in the course of the 2-2 motion M2-2 passes between the plurality of third tooth portions 542b of the 2-1 gear 542 of the first control unit 500.

The rotating member 800 passing between the plurality of third tooth portions 542b of the 2-1 gear 542 comes into contact with the fourth tooth portion 544b of the 2-2 gear 544 of the first control unit 500. More specifically, the rotating member 800 passing between the plurality of third tooth portions 542b of the 2-1 gear 542 comes into contact with the slanted surface of the fourth tooth portion 544b of the 2-2 gear 544. Here, the slanted surface of the fourth tooth portion 544b of the 2-2 gear 544 is rotated downward by the rotation force of the rotating member 800 in terms of FIGS. 20b and 21.

As a result, the shaft 560 and the second connecting block 580, connected to the 2-1 gear 542, of the first gear unit 520 rotate upward along with the 2-1 gear 542. At this time, the second connecting block 580 is engagingly connected to the first connecting block 340 of the first wing assembly 300. As a result, when the second connecting block 580 rotates upward, the first connecting block 340 rotates downward. Thereby, the first wing 320 connected to the first connecting block 340 also rotates downward.

The rotating member 800, of which the contact with the fourth tooth portion 544b of the 2-2 gear 544 is terminated, is disposed at the third location L3 in the course of the 2-2 motion M2-2. Thereby, the second motion M2 including the 2-2 motion M2-2 is terminated.

As illustrated in FIG. 21, the first wing 320 may close the lower space of the inlet portion 120 of the housing 100 while simultaneously guiding the air entering the housing 100 into the upper space of the inlet portion 120 of the housing 100. The air guided into the upper space of the inlet portion 120 of the housing 100 may move through the first guide portion 142 of the housing 100, and the air passing through a first guide hole 142a of the housing 100 and the third guide hole 222 of the garnish 200 may be guided through the third guide portion 220 of the garnish 200 to move finally toward the floor surface of the passenger compartment of the vehicle.

In this way, the rotating member 800 may rotate the first wing 320 by ¼ of 90° as the actuator 700 causes the rotating member 800 to perform the second motion M2. When this process is repeated four times, as illustrated in FIG. 21, the first wing 320 may fully close the lower space of the inlet portion 120 of the housing 100.

In this way, the vehicle air vent 1 according to an embodiment of the present invention may guide air toward the ceiling surface or bottom surface of the vehicle through the first motion M1 or the second motion M2 of the rotating member 800.

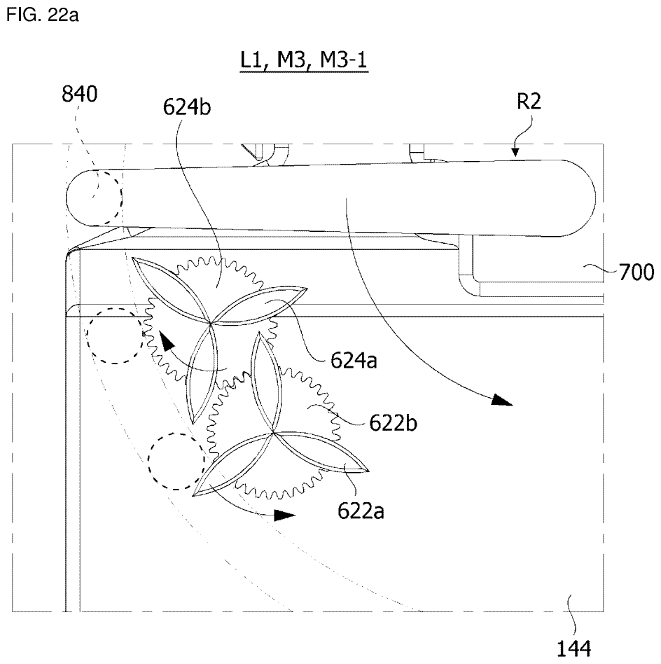

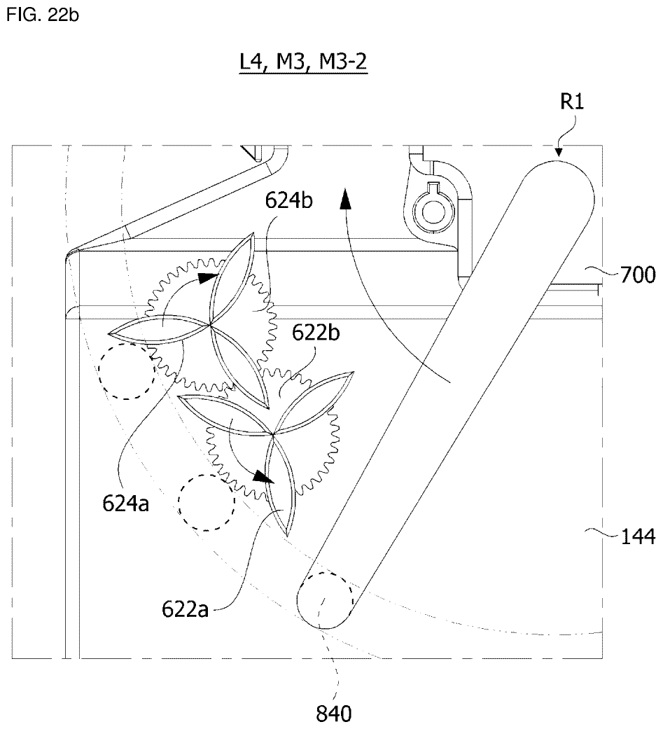

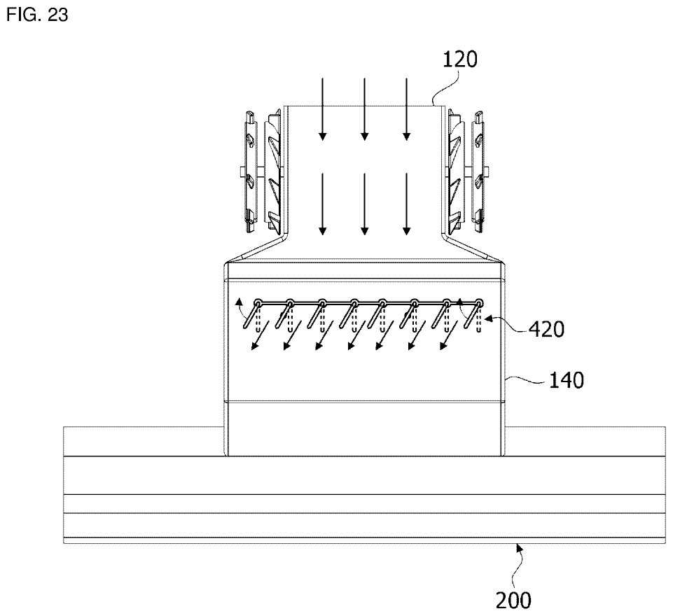

FIG. 22a is a view illustrating the process of the rotating member coming into contact with the 3-1 gear of the second control unit, FIG. 22b is a view illustrating the process of the rotating member coming into contact with the 3-3 gear of the second control unit, and FIG. 23 is a view illustrating the second wing rotated leftward.

FIGS. 17 and 22a to 23 show that the second wing 420 may rotate to guide air toward the side (e.g., left-hand side) of the passenger compartment of the vehicle as the third gear unit 620 of the second control unit 600 is rotated by the rotation of the rotating member 800. In the following, as illustrated in FIGS. 17, 22a, and 22b, the vehicle air vent 1 according to the present embodiment will be described as viewed from below.

First, as illustrated in FIG. 23, in the state where the rotating member 800 is yet to perform a third motion M3 to be described below, the second wing 420 remains parallel to the second airflow direction.

In addition, in this state, as illustrated in FIG. 22a, the rotating member 800 is disposed at the first location L1. In addition, the rotating member 800 may rotate around the third control unit and the second control unit 600 to be disposed at the first location L1.

In this state, the actuator 700 may generate a mechanical force for operating the rotating member 800 so that the rotating member 800 may perform the third motion M3 when a motion signal is delivered to the actuator 700. Here, the third motion M3 is a reciprocating motion of the rotating member 800, and the third motion M3 may be divided into a 3-1 motion M3-1 and a 3-2 motion M3-2.

In the state where the rotating member 800 is disposed at the first location L1, the 3-1 gear 622a of the 3a gear unit 622 of the second control unit 600 is disposed on the rotation path of the rotating member 800, and the 3-3 gear 624a of the 3b gear unit 624 is disposed outside the rotation path of the rotating member 800. As a result, the actuator 700 causes the rotating member 800 to rotate to perform the 3-1 motion M3-1. When the rotating member 800 rotates to perform the 3-1 motion M3-1, the rotating member 800 comes into contact with the 3-1 gear 622a of the 3a gear unit 622 of the second control unit 600. Here, the rotating member 800 rotates in the second rotation direction R2.

When the rotating member 800 comes into contact with the 3-1 gear 622a of the 3a gear unit 622 of the second control unit 600, the 3-1 gear 622a rotates in the second rotation direction R2. When the 3-1 gear 622a rotates, the 3-2 gear 622b connected to the 3-1 gear 622a also rotates. As a result, when the 3-1 gear 622b rotates, the support block 440, connected to the 3-2 gear 622b, of the second wing assembly 400 rotates, and when the support block 440 rotates, the plurality of second wings 420 forming the 2-2 wing unit 424 rotates.

The rotating member 800, of which the contact with the 3-1 gear 622a of the 3a gear unit 622 is terminated, is disposed at the fourth location L4 in the course of the 3-1 motion M3-1. Thereby, the 3-1 motion M3-1 is terminated. In the state where the 3-1 motion M3-1 is terminated, as illustrated in FIG. 22b, the 3-1 gear 622a of the 3-1 gear unit 622 is disposed outside the rotation path of the rotating member 800, and the 3-3 gear 624a of the 3b gear unit 624 is disposed on the rotation path of the rotating member 800. As a result, the rotating member 800 falls into a state where the rotating member 800 may come into contact with the 3-3 gear 624a of the 3b gear unit 624.

The actuator 700 causes the rotating member 800 to perform the 3-2 motion M3-2 after the 3-1 motion M3-1 is terminated. The 3-1 motion M3-2 is a motion by which the rotating member 800 rotates to switch from the fourth location L4 to the first location L1, and, as illustrated in FIG. 22b, the contact portion 840 of the rotating member 800 in the course of the 3-2 motion M3-2 comes into contact with the 3-3 gear 624a of the 3b gear unit 624.

When the contact portion 840 of the rotating member 800 comes into contact with the 3-3 gear 624a of the 3b gear unit 624, the 3-3 gear 624a rotates in the first rotation direction R1. When the 3-3 gear 624a rotates, the 3-4 gear 624b connected to the 3-3 gear 624a also rotates. As a result, when the 3-4 gear 624b rotates, the 3-2 gear 622b, connected to the 3-4 gear 624b, of the 3a gear unit 622 rotates, and when the 3-2 gear 622b rotates, the 3-1 gear 622a connected to the 3-2 gear 622b rotates. Here, the 3-1 gear 622a and the 3-2 gear 622b rotate in the second rotation direction R2.

When the 3-1 gear 622a rotates, the 3-2 gear 622b connected to the 3-1 gear 622a also rotates. As a result, when the 3-2 gear 622b rotates, the support block 440, connected to the 302 gear 622b, of the second wing assembly 400 rotates, and when the support block 440 rotates, the plurality of second wings 420 forming the 2-2 wing unit 424 rotates. When the plurality of second wings 420 forming the 2-2 wing unit 424 rotates, the plurality of second wings 420 forming the 2-1 wing unit 422, connected to the support block 440, rotates. Finally, when the vehicle air vent 1 is viewed from above as in FIG. 23, the second wing 420 may guide air toward the left-hand side of the housing 100.

The rotating member 800, of which the contact with the 3-3 gear 624a of the 3b gear unit 624 is terminated, is disposed at the first location L1 in the course of the 3-2 motion M3-2. Thereby, the third motion M3 including the 3-2 motion M3-2 is terminated.

In this way, the rotating member 800 may rotate the second wing 420 by ¼ of 90° as the actuator 700 causes the rotating member 800 to perform the third motion M3. When this process is repeated four times, as illustrated in FIG. 23, the second wing 420 may guide air toward the left-hand side of the housing 100.

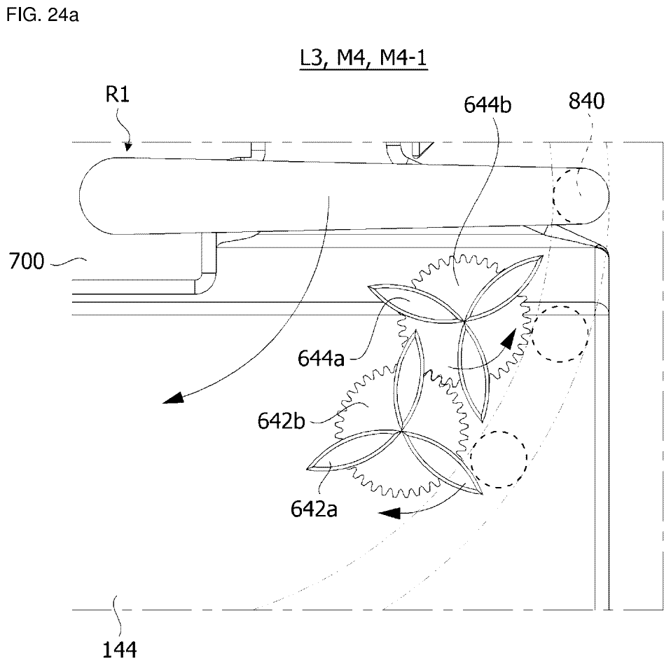

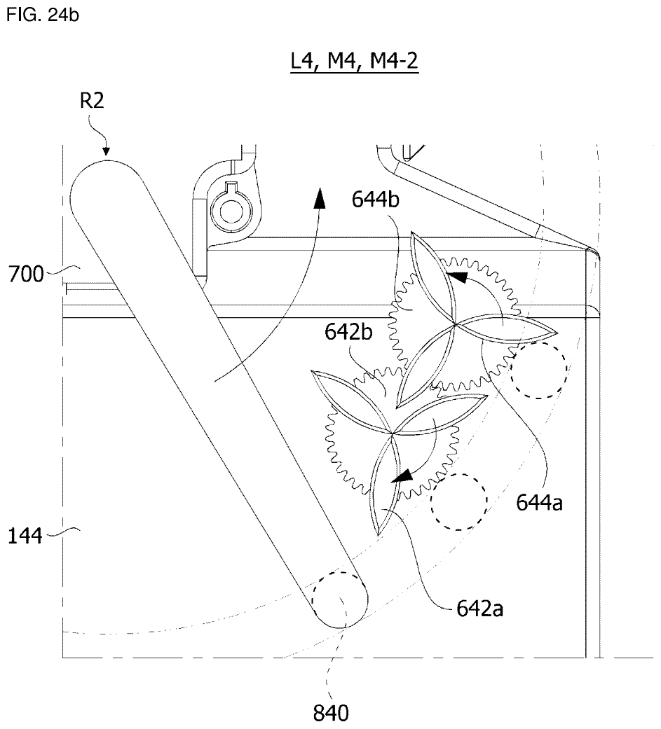

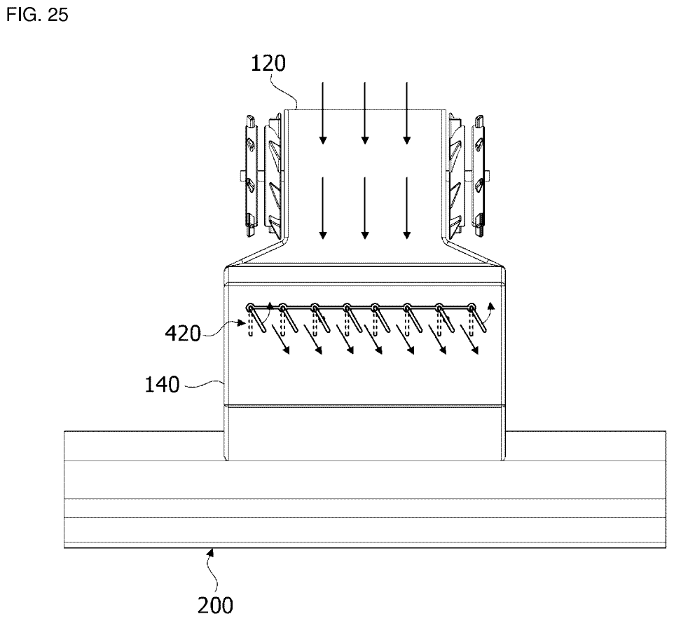

FIG. 24a is a view illustrating a process of the rotating member coming into contact with the 4-1 gear of the second control unit, FIG. 24b is a view illustrating a process of the rotating member coming into contact with the 4-3 gear of the second control unit, and FIG. 25 is a view illustrating the second wing rotated rightward.

FIGS. 17 and 24a to 25 show that the second wing 420 may rotate to guide air toward the side (e.g., right-hand side) of the passenger compartment of the vehicle as the fourth gear unit 640 of the second control unit 600 is rotated by the rotation of the rotating member 800. In the following, as illustrated in FIGS. 17, 24a, and 24b, the vehicle air vent 1 according to the present embodiment will be described as viewed from below.

First, as illustrated in FIG. 25, in a state where the rotating member 800 is yet to perform the third motion M3 to be described below, the second wing 420 remains parallel to the second airflow direction.

In addition, in this state, as illustrated in FIG. 24a, the rotating member 800 is disposed at the third location L3. In addition, the rotating member 800 may rotate around the third control unit and the second control unit 600 to be disposed at the third location L3.

In this state, the actuator 700 may generate a mechanical force for operating the rotating member 800 such that the rotating member 800 may perform the fourth motion M4 when a motion signal is delivered to the actuator 700. Here, the fourth motion M4 is a reciprocating motion of the rotating member 800, and the fourth motion M4 may be divided into a 4-1 motion M4-1 and a 4-2 motion M4-2 as described above.

In addition, in the state where the rotating member 800 is disposed at the third location L3, the 4-1 gear 642a of the 4a gear unit 642 of the second control unit 600 is disposed on the rotation path of the rotating member 800, and the 4-3 gear 644a of the 4b gear unit 644 is disposed outside the rotation path of the rotating member 800. As a result, the actuator 700 causes the rotating member 800 to rotate to perform the 4-1 motion M4-1. When the rotating member 800 rotates to perform the 4-1 motion M4-1, the rotating member 800 comes into contact with the 4-1 gear 642a of the 4a gear unit 642 of the second control unit 600. Here, the rotating member 800 rotates in the first rotation direction R1.

When the rotating member 800 comes into contact with the 4-1 gear 642a of the 4a gear unit 642 of the second control unit 600, the 4-1 gear 642a rotates in the first rotation direction R1. When the 4-1 gear 642a rotates, the 4-2 gear 642b connected to the 4-1 gear 642a also rotates. As a result, when the 4-1 gear 642b rotates, the support block 440, connected to the 4-2 gear 642b, of the second wing assembly 400 rotates, and when the support block 440 rotates, the plurality of second wings 420 forming the 2-2 wing unit 424 rotates.

The rotating member 800, of which the contact with the 4-1 gear 642a of the 4a gear unit 642 is terminated, is disposed at the fourth location L4 in the course of the 4-1 motion M4-1. Thereby, the 43-1 motion M4-1 is terminated. In the state where the 4-1 motion M4-1 is terminated, as illustrated in FIG. 24b, the 4-1 gear 642a of the 4-1 gear unit 642 is disposed outside the rotation path of the rotating member 800, and the 4-3 gear 644a of the 4b gear unit 644 is disposed on the rotation path of the rotating member 800. As a result, the rotating member 800 falls into a state where the rotating member 800 may come into contact with the 4-3 gear 644a of the 4b gear unit 644.

The actuator 700 causes the rotating member 800 to perform the 4-2 motion M4-2 after the 4-1 motion M4-1 is terminated. The 4-2 motion M4-2 is a motion by which the rotating member 800 rotates to switch from the fourth location L4 to the third location L3, and, as illustrated in FIG. 24b, the contact portion 840 of the rotating member 800 in the course of 4-2 motion M4-2 comes into contact with the 4-3 gear 644a of the 4b gear unit 644.

When the contact portion 840 of the rotating member 800 comes into contact with the 4-3 gear 644a of the 4b gear unit 644, the 4-3 gear 644a rotates in the second rotation direction R2. When the 4-3 rear 644a rotates, the 4-4 gear 644b connected to the 4-3 gear 644a also rotates. As a result, when the 4-4 gear 644b rotates, the 4-2 gear 642b, connected to the 4-4 gear 644b, of the 4a gear unit 642 rotates, and when the 4-2 gear 642b rotates, the 4-2 gear 642a connected to the 4-2 gear 642b rotates. Here, the 4-1 gear 642a and the 4-2 gear 642b rotate in the first rotation direction R1.

When the 4-1 gear 642a rotates, the 4-2 gear 642b connected to the 4-1 gear 642a also rotates. As a result, when the 4-2 gear 642b rotates, the support block 440, connected to the 4-2 gear 642b, of the second wing assembly 400 rotates, and when the support block 440 rotates, the plurality of second wings 420 forming the 2-2 wing unit 424 rotates. When the plurality of second wings 420 forming the 2-2 wing unit 424 rotates, the plurality of second wings 420 forming the 2-1 wing unit 422, connected to the support block 440, rotates. Finally, when the vehicle air vent 1 is viewed from above as in FIG. 25, the second wing 420 may guide air toward the right-hand side of the housing 100.

The rotating member 800, of which the contact with the 4-3 gear 644a of the 4b gear unit 644 is terminated is disposed at the third location L3 in the course of the 4-2 motion M4-2. Thereby, the fourth motion M4 including the 4-2 motion M4-2 is terminated.

In this way, the rotating member 800 may rotate the second wing 420 by ¼ of 90° as the actuator 700 causes the rotating member 800 to perform the fourth motion M4. When this process is repeated four times, as illustrated in FIG. 25, the second wing 420 may guide air toward the right-hand side of the housing 100.

In this way, the vehicle air vent 1 according to an embodiment of the present invention may guide air toward the side of the vehicle through the third motion M3 or the fourth motion M4 of the rotating member 800.

The vehicle air vent 1 according to an embodiment of the present invention may have a first wing 320 and second wing 420 that are rotated by the mechanical force generated by the single actuator 700. As a result, the need to provide a plurality of actuators 700 to individually control the first wing 320 and the second wing 420 that guide air in intersecting directions may be eliminated. As a result, manufacturing costs may be reduced and the productivity of the vehicle air vent 1 may improve.

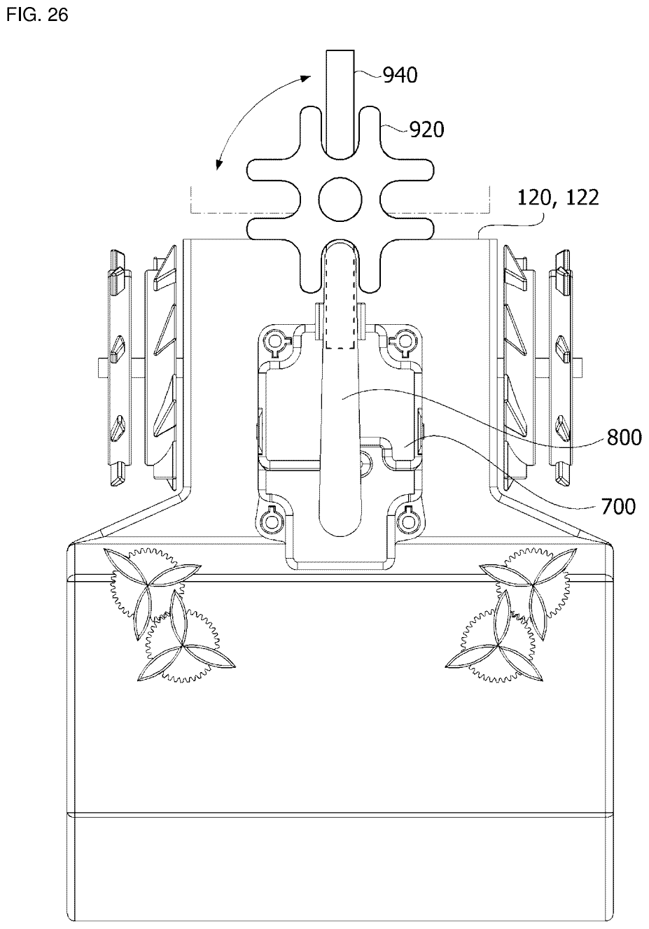

FIG. 26 is a view illustrating an air volume control gear and a damper disposed near the inlet portion of the housing.

FIG. 26 shows that the vehicle air vent 1 according to an embodiment of the present invention may further include an air volume control gear 920 and a damper 940.

The air volume control gear 920 and the damper 940 may be disposed at a location close to the inlet hole 122 of the inlet portion 120 of the housing 100. The air volume control gear 920 may be rotatably coupled to the housing 100. The air volume control gear 920 may have a shape engaging the rotating member 800. The air volume control gear 920 may have four engaging portions.

The damper 940 may be coupled to the air volume control gear 920 to rotate simultaneously when the air volume control gear 920 rotates. When the air volume control gear 920 rotates, the damper 940 may open or close the inlet hole 122 of the housing 100 while rotating along with the air volume control gear 920.

The combination of the air volume control gear 920 and the camper 940 may regulate the air volume entering the housing 100. To this end, the air volume control gear 920 may have a shaping engaging the rotating member 800 four times but is not limited thereto.

According to an embodiment of the present invention, control units configured to rotate the first wing and the second wing may be disposed on the rotation path of the rotating member coupled to the actuator. As a result, the need to employ a plurality of actuators is eliminated to reduce manufacturing costs and improve productivity.

The above description has been provided with reference to the embodiment of the present invention. However, it will be understood by those skilled in the art that various modifications and changes may be made to the present invention within the scope not deviating from the spirit and scope of the present invention as set forth in the claims below. Any difference relating to such modifications and changes is to be construed as falling within the scope of the present invention as defined by the appended claims.

DESCRIPTION OF REFERENCE NUMERALS

| | |
|---|---|
| 1: vehicle air vent | 100: housing |
| 120: inlet portion | 122: inlet hole |
| 140: guide portion | 142: first guide portion |
| 142a: first guide hole | 144: second guide portion |
| 144a: second guide hole | 160: split portion |
| 200: garnish | 220: third guide portion |
| 222: third guide hole | 240: fourth guide portion |
| 242: fourth guide hole | 260: blocking portion |
| 300: first wing assembly | 320: first wing |
| 340: first connecting block | 400: second wing assembly |
| 420: second wing | 422: 2-1 wing unit |
| 424: 2-2 wing unit | 440: support block |
| 460: union block | 500: first control unit |
| 520: first gear unit | 522: 1-1 gear |
| 522a: first plate portion | 522b: first tooth portion |
| 524: 1-2 gear | 524a: second plate portion |
| 524b: second tooth portion | 540: second gear unit |
| 542: 2-1 gear | 542a: third plate portion |
| 542b: third tooth portion | 544: 2-2 gear |
| 544a: fourth plate portion | 544b: fourth tooth portion |
| 560: shaft | |
| 580: second connecting block | |
| 600: second control unit | 620: third gear unit |
| 622: 3a gear unit | 622a: 3-1 gear |
| 622b: 3-2 gear | 624: 3b gear unit |
| 624a: 3-3 gear | 624b: 3-4 gear |
| 640: fourth gear unit | 642: 4a gear unit |
| 642a 4-1 gear | 642b: 4-2 gear |
| 644: 4b gear unit | 644a: 4-3 gear |
| 644b: 4-4 gear | 700: actuator |
| 800: rotating member | 820: coupling portion |
| 840: contact portion | 860: body portion |
| 920: air volume control gear | 940: damper |
| L1: first location | L2: second location |
| L3: third location | L4: fourth location |
| M1: first motion | M1-1: 1-1 motion |
| M1-2: 1-2 motion | M2: second motion |
| M2-1: 2-1 motion | M2-2: 2-2 motion |
| M3: third motion | M3-1: 3-1 motion |
| M3-2: 3-2 motion | M4: fourth motion |
| M4-1: 4-1 motion | M4-2: 4-2 motion |
| R1: first rotation direction | |
| R2: second rotation direction | |

What is claimed is:

1. A vehicle air vent for being installed in a vehicle to guide air in a passenger compartment of the vehicle, the vehicle air vent comprising:
a first wing assembly including a first wing for guiding air toward at least one of a ceiling surface of the passenger compartment, a floor surface of the passenger compartment, or a combination thereof;
a second wing assembly including a plurality of second wings for guiding air toward a side of the passenger compartment; and
a single actuator disposed between the first wing assembly and the second wing assembly,
wherein the single actuator is configured to generate a mechanical force to rotate the first wing and the plurality of second wings.

2. The vehicle air vent of claim 1, further comprising:
a housing for accommodating the first wing and the plurality of second wings therein, the housing including a path for air to flow therethrough; and
a rotating member connected to the actuator,
wherein the rotating member is rotated by the mechanical force generated by the actuator to operate the first wing and the plurality of second wings.

3. The vehicle air vent of claim 2, wherein the actuator and the rotating member are disposed outside of the housing.

4. The vehicle air vent of claim 2, further comprising:
a first control unit rotatably coupled to the housing and configured to control the rotation direction and rotation angle of the first wing while rotating in conjunction with the rotation of the rotating member,
wherein the first control unit includes:
a first gear unit for rotating the first wing upward while rotating in selective contact with the rotating member reciprocating along a predetermined section; and
a second gear unit for rotating the first wing downward while rotating in selective contact with the rotating member reciprocating along a predetermined section.

5. The vehicle air vent of claim 4,
wherein the first gear unit includes:
a gear (1-1) for rotating in contact with the rotating member rotating in a first rotation direction; and
a gear (1-2) for rotating in contact with the rotating member rotating in a second rotation direction, and
wherein the second gear unit includes:
a gear (2-1) for rotating in contact with the rotating member rotating in the second rotation direction; and
a gear (2-2) for rotating in contact with the rotating member rotating in the first rotation direction.

6. The vehicle air vent of claim 4,
wherein the first wing assembly includes a first connecting block coupled to the first wing and serving as a rotation center of the first wing,
wherein the first control unit includes a shaft connecting the first gear unit and the second gear unit and a second connecting block coupled to the shaft and engaging the first connecting block in a state of being disposed inside the housing, and
wherein the first wing and the first connecting block rotate in a direction opposite the rotation direction of the second connecting block while rotating in conjunction with the rotation of the second connecting block.

7. The vehicle air vent of claim 5, further comprising:
a second control unit disposed outside the housing and configured to control the rotation direction and the rotation angle of the plurality of second wings while rotating in conjunction with the rotation of the rotating member,
wherein the second control unit includes:
a third gear unit for rotating the plurality of second wings in a first rotation direction while rotating in selective contact with the rotating member reciprocating along a predetermined section; and
a fourth gear unit for rotating the plurality of second wings in a second rotation direction opposite the first rotation direction while rotating in selective contact with the rotating member reciprocating along a predetermined section.

8. The vehicle air vent of claim 7, wherein the third gear unit includes:
a gear unit (3a) including a gear (3-1) for rotating in contact with the rotating member rotating in the second rotation direction, and a gear (3-2) coupled to the gear (3-1) and coupled to any one of the plurality of second wings; and
a gear unit (3b) including a gear (3-3) for rotating in contact with the rotating member rotating in the first rotation direction, and a gear (3-4) coupled to the gear (3-3) and rotatably coupled to the housing.

9. The vehicle air vent of claim 8, wherein the fourth gear unit includes:
a gear unit (4a) including a gear (4-1) for rotating in contact with the rotating member rotating in the first rotation direction, and a gear (4-2) coupled to the gear (4-1) and coupled to any one of the plurality of second wings; and
a gear unit (4b) including a gear (4-3) for rotating in contact with the rotating member rotating in the second rotation direction, and a gear (4-4) coupled to the gear (4-3) and rotatably coupled to the housing.

10. The vehicle air vent of claim 7, wherein the first control unit and the second control unit are disposed on a rotation path of the rotating member.

11. An air vent to guide air in a passenger compartment of a vehicle, the air vent comprising:
a first wing assembly including a first wing;
a second wing assembly including a second wing;
a single actuator disposed between the first wing assembly and the second wing assembly; and
a processor configured to control the single actuator to provide a mechanical force,
wherein the processor is further configured to control the actuator to at least one of:
actuate the first wing assembly to rotate the first wing to guide air toward at least one of a ceiling surface of the passenger compartment, a floor surface of the passenger compartment, or a combination thereof;
actuate the second wing assembly to rotate the second wing to guide air toward a left side or a right side of the passenger compartment; or
a combination thereof.

12. The air vent of claim 11, further comprising:
a housing for accommodating the first wing and the second wing therein, the housing including a path for air to flow therethrough; and
a rotating member connected to the actuator,
wherein the rotating member is rotated by the mechanical force generated by the actuator to operate the first wing and the second wing.

13. The air vent of claim 12, further comprising:
a first control unit rotatably coupled to the housing, the first control unit including a first gear set and a second gear set,
wherein the processor is further configured to:
control the first control unit to control the rotation direction and rotation angle of the first wing while rotating in conjunction with the rotation of the rotating member,
control the first gear set to rotate the first wing upward while rotating in selective contact with the rotating member reciprocating along a predetermined section; and
control the second gear set to rotate the first wing downward while rotating in selective contact with the rotating member reciprocating along a predetermined section.
